(19) United States
(12) Patent Application Publication
(10) Pub. No.: US 2026/0270580 A1
(43) Pub. Date: Sep. 10, 2026

(54) IMAGING DEVICE, IMAGE PROCESSING DEVICE, AND IMAGING DEVICE CONTROL METHOD

(71) Applicant: Sony Semiconductor Solutions Corporation, Kanagawa (JP)

(72) Inventor: Takashi Hosoe, Kanagawa (JP)

(21) Appl. No.: 18/727,571

(22) PCT Filed: Jan. 5, 2023
(86) PCT No.: PCT/JP2023/000064

§ 371 Date: Oct. 29, 2025

(30) Foreign Application Priority Data
Mar. 1, 2022 (JP) 2022-030563

(51) Int. Cl. H04N 25/531; H04N 25/532; H04N 25/771; H04N 25/772

(52) U.S. Cl. CPC H04N 25/531; H04N 25/532; H04N 25/771; H04N 25/772

(57) ABSTRACT

The present technology relates to easing of timing constraints on output of a pixel signal used for feature data.

An imaging device includes a signal generation unit, a sample-and-hold circuit, a first vertical signal line, a second vertical signal line, a first switch, and a second switch. The signal generation unit generates a signal on the basis of charges read from the photoelectric conversion unit. The sample-and-hold circuit holds the signal generated by the signal generation unit. The first vertical signal line transmits the signal read from the sample-and-hold circuit. The second vertical signal line transmits the signal generated by the signal generation unit. The first switch is provided between the signal generation unit and the sample-and-hold circuit. The second switch is provided between the signal generation unit and the second vertical signal line.

### TECHNICAL FIELD

The present technology relates to an imaging device. Specifically, the present technology relates to an imaging device that performs a global shutter operation and a rolling shutter operation, an image processing device, and an imaging device control method.

### BACKGROUND ART

For imaging devices, there is a rolling shutter method in which an analog to digital converter (ADC) is arranged for each column outside a pixel array unit, and exposure is started row by row under a column ADC method in which pixel signals are sequentially read row by row. In addition, a global shutter method has been proposed in which a pair of capacitors for holding a reset level and a signal level is provided for each pixel, and exposure is simultaneously started for all pixels (see, for example, Non-Patent Document 1).

Further, there is an increasing demand for recognition using artificial intelligence (AI) or the like, and there is a demand for output of feature data used for recognition or the like typified by phase difference information together with a high-resolution normal image used for viewing or the like.

### CITATION LIST

### Non-Patent Document

Non-Patent Document 1: Jae-kyu Lee, et al., A 2.1e-Temporal Noise and −105 dB Parasitic Light Sensitivity Backside-Illuminated 2.3 μm-Pixel Voltage-Domain Global Shutter CMOS Image Sensor Using High-Capacity DRAM Capacitor Technology, ISSCC 2020.

### SUMMARY OF THE INVENTION

### Problems to be Solved by the Invention

However, in the above-described technology in the related art, a vertical signal line that outputs the pixel signal used for the feature data is also used as a vertical signal line that outputs the pixel signal used for the normal image. Accordingly, when the vertical signal line is used to output the pixel signal used for the normal image, the pixel signal used for the feature data cannot be output, so that timing constraints on output of the pixel signal used for the feature data are significant.

The present technology has been made in view of such circumstances, and it is therefore an object of the present technology to ease timing constraints on output of a pixel signal used for feature data.

### Solutions to Problems

The present technology has been made to solve the above-described problems, and a first aspect of the present technology is an imaging device including: a signal generation unit configured to generate a signal on the basis of charges read from a photoelectric conversion unit; a sample-and-hold circuit configured to hold the signal generated by the signal generation unit; a first vertical signal line configured to transmit the signal read from the sample-and-hold circuit; a second vertical signal line configured to transmit the signal generated by the signal generation unit; a first switch provided between the signal generation unit and the sample-and-hold circuit; and a second switch provided between the signal generation unit and the second vertical signal line. This brings about an effect that the signal generated on the basis of the charges read from the photoelectric conversion unit and the signal read from the sample-and-hold circuit are output in parallel.

In addition, the first aspect may further include: a first analog to digital converter (ADC) configured to perform AD conversion on the signal output to the first vertical signal line for each column; and a second ADC configured to perform AD conversion on the signal output to the second vertical signal line for each column. This brings about an effect that the signal generated on the basis of the charges read from the photoelectric conversion unit and the signal read from the sample-and-hold circuit are AD-converted in parallel.

In addition, the first aspect may further include: a first interface configured to transmit a signal output from the first ADC to outside; and a second interface configured to transmit a signal output from the second ADC to outside. This brings about an effect that the signal generated on the basis of the charges read from the photoelectric conversion unit and the signal read from the sample-and-hold circuit are transmitted in parallel.

In addition, the first aspect may further include an interface configured to transmit a signal output from the first ADC and a signal output from the second ADC to outside in a time-division manner. This brings about an effect that the signal generated on the basis of the charges read from the photoelectric conversion unit and the signal read from the sample-and-hold circuit are transmitted via one interface.

In addition, the first aspect may further include a vertical scanning circuit configured to control timing at which the signal read from the sample-and-hold circuit is output to the first vertical signal line and timing at which the signal generated by the signal generation unit is output to the second vertical signal line. This brings about an effect that the output timing of the signal generated on the basis of the charges read from the photoelectric conversion unit is controlled separately from the output timing of the signal read from the sample-and-hold circuit.

In addition, according to the first aspect, the vertical scanning circuit may cause the signal generated by the signal generation unit to be output to the second vertical signal line while the signal read from the sample-and-hold circuit is being output to the first vertical signal line. This brings about an effect that real-time performance of the output of the signal generated on the basis of the charges read from the photoelectric conversion unit is improved.

In addition, according to the first aspect, the vertical scanning circuit may cause a signal generated by exposure using a global shutter method to be held in the sample-and-hold circuit and cause a signal generated by exposure using a rolling shutter method to be output to the second vertical signal line. This brings about an effect that a high-resolution image without rolling shutter distortion can be obtained while allowing the output of feature data.

In addition, according to the first aspect, the vertical scanning circuit may cause the signal generated by the signal generation unit to be output to the second vertical signal line a plurality of times within a vertical synchronization period. This brings about an effect that real-time performance of the output of the signal generated on the basis of the charges read from the photoelectric conversion unit is improved.

In addition, according to the first aspect, the signal generated by the signal generation unit may include at least one of region of interest (ROI) image data, reduced image data, or phase difference data. This brings about an effect that feature data for recognition, exposure adjustment, motion detection, focus adjustment, or the like is output while allowing the output of a high-resolution image without rolling shutter distortion.

In addition, the first aspect may further include a control unit configured to control at least one of a global shutter operation or a rolling shutter operation on the basis of the signal transmitted through the second vertical signal line. This brings about an effect that imaging control is performed on the basis of the signal read from the photoelectric conversion unit.

In addition, according to the first aspect, the signal generation unit may include: a readout transistor configured to read the charges from the photoelectric conversion unit; a floating diffusion configured to hold the charges read by the readout transistor; an amplification transistor configured to generate the signal on the basis of a potential of the floating diffusion; and a reset transistor configured to reset the charges held in the floating diffusion, and the sample-and-hold circuit may include: a first capacitor element having one end connected to the first switch; a second capacitor element having one end connected to the first switch; a first switching transistor connected in series to the first capacitor element; and a second switching transistor connected in series to the second capacitor element. This brings about an effect that a voltage-domain sample-and-hold circuit is used.

In addition, the first aspect may further include: an output circuit configured to output the signal held in the sample-and-hold circuit to the first vertical signal line; and a post-stage reset transistor configured to initialize a level of a connection point between the sample-and-hold circuit and the output circuit when both the first and second capacitor elements are disconnected from the output circuit. This brings about an effect that that the level of the reset noise is set to a level corresponding to the parasitic capacitance when the first and second capacitor elements are disconnected.

In addition, a second aspect is an image processing device including: a pixel array unit in which a pixel provided with a sample-and-hold circuit is arranged in a row direction and a column direction; a first output unit configured to output a signal from the sample-and-hold circuit on the basis of a global shutter operation; a second output unit configured to output, from the pixel, a signal that has skipped the sample-and-hold circuit on the basis of a rolling shutter operation; a first processing unit configured to process the signal output from the first output unit; a second processing unit configured to process the signal output from the second output unit; and a combining unit configured to combine the signal processed by the first processing unit and the signal processed by the second processing unit. This brings about an effect that the image from which rolling shutter distortion has been removed is processed on the basis of the feature data obtained on the basis of the rolling shutter operation.

In addition, according to the second aspect, the pixel may include: a photoelectric conversion unit; a readout transistor configured to read charges from the photoelectric conversion unit; a floating diffusion configured to hold the charges read by the readout transistor; an amplification transistor configured to generate a signal corresponding to a potential of the floating diffusion; and a reset transistor configured to reset the charges held in the floating diffusion. This brings about an effect that the image signal and the feature data are generated from each pixel.

In addition, the second aspect may further include: a first switch provided between the amplification transistor and the sample-and-hold circuit; and a second switch provided between the amplification transistor and the second output unit, in which the sample-and-hold circuit may include: a first capacitor element having one end connected to the first switch; a second capacitor element having one end connected to the first switch; a first switching transistor connected in series to the first capacitor element; and a second switching transistor connected in series to the second capacitor element. This brings about an effect that the signal that has skipped the sample-and-hold circuit on the basis of the rolling shutter operation is output.

In addition, according to the second aspect, the first output unit may include: a first vertical signal line configured to transmit the signal read from the sample-and-hold circuit in the column direction; and a first ADC configured to perform AD conversion on the signal output to the first vertical signal line for each column, and the second output unit may include: a second vertical signal line configured to transmit the signal that has skipped the sample-and-hold circuit in the column direction; and a second ADC configured to perform AD conversion on the signal output to the second vertical signal line for each column. This brings about an effect that the signal generated on the basis of the charges read from the photoelectric conversion unit and the signal read from the sample-and-hold circuit are AD-converted in parallel.

In addition, according to the second aspect, the signal that has skipped the sample-and-hold circuit may be output from the pixel to the second output unit a plurality of times within a vertical synchronization period. This brings about an effect that real-time performance of the output of the signal that has skipped the sample-and-hold circuit on the basis of the rolling shutter operation is improved.

In addition, according to the second aspect, the signal output from the pixel to the second output unit may include at least one of ROI image data, reduced image data, or phase difference data. This brings about an effect that feature data for recognition, exposure adjustment, motion detection, focus adjustment, or the like is output while allowing the output of a high-resolution image without rolling shutter distortion.

In addition, the second aspect may further include a control unit configured to control the pixel array unit on the basis of the signal processed by the second processing unit. This brings about an effect that the pixel array unit is controlled on the basis of the signal read from the photoelectric conversion unit.

In addition, a third aspect is an imaging device control method including: generating a signal on the basis of charges read from a photoelectric conversion unit provided in a pixel; holding, in the pixel, the signal generated in the pixel; outputting the signal held in the pixel; and outputting the signal generated in the pixel within an output period of the signal held in the pixel. This brings about an effect that the signal generated on the basis of the charges read from the photoelectric conversion unit and the signal held in the pixel are output in parallel.

### BRIEF DESCRIPTION OF DRAWINGS

FIG. 1 is a block diagram depicting a configuration example of an imaging device according to a first embodiment.

FIG. 2 is a block diagram depicting a configuration example of a solid-state imaging element according to the first embodiment.

FIG. 3 is a diagram depicting a configuration example of a pixel according to the first embodiment.

FIG. 4 is a diagram depicting a configuration example of a pixel circuit according to the first embodiment.

FIG. 5 is a block diagram depicting a configuration example of a column signal processing circuit and a load MOS circuit block according to the first embodiment.

FIG. 6 is a diagram depicting an example of how the imaging device according to the first embodiment operates.

FIG. 7 is a timing chart depicting an example of a read operation of the imaging device according to the first embodiment.

FIG. 8 is a diagram depicting normal image data and a first example of feature data according to the first embodiment.

FIG. 9 is a diagram depicting the normal image data and a second example of the feature data according to the first embodiment.

FIG. 10 is a diagram depicting the normal image data and a third example of the feature data according to the first embodiment.

FIG. 11 is a diagram depicting an arrangement example of image plane phase difference pixels used for reading phase difference data according to the first embodiment.

FIG. 12 is a diagram depicting the normal image data and a fourth example of the feature data according to the first embodiment.

FIG. 13 is a diagram depicting an example of a configuration and an operation of an image processing device according to a second embodiment.

FIG. 14 is a diagram depicting an example of a configuration and an operation of an image processing device according to a third embodiment.

FIG. 15 is a diagram depicting an example of a format used when the image processing device according to the third embodiment transmits data.

FIG. 16 is a diagram depicting an example of a configuration and an operation of an image processing device according to a fourth embodiment.

FIG. 17 is a diagram depicting an example of a configuration and an operation of an image processing device according to a fifth embodiment.

FIG. 18 is a circuit diagram depicting a configuration example of a pixel according to a sixth embodiment.

FIG. 19 is a timing chart depicting an example of a global shutter operation according to the sixth embodiment.

FIG. 20 is a timing chart depicting an example of a read operation according to the sixth embodiment.

FIG. 21 is a timing chart depicting another example of the read operation according to the sixth embodiment.

FIG. 22 is a diagram depicting examples of respective states of the pixel at the time of reading a reset level and at the time of initializing a post-stage node according to the sixth embodiment.

FIG. 23 is a diagram depicting an example of a state of the pixel at the time of reading a signal level according to the sixth embodiment.

FIG. 24 is a circuit diagram depicting a configuration example of a pixel according to a first modification example of the sixth embodiment.

FIG. 25 is a timing chart depicting an example of a global shutter operation according to the first modification example of the sixth embodiment.

FIG. 26 is a timing chart depicting an example of a read operation according to the first modification example of the sixth embodiment.

FIG. 27 is a diagram depicting an example of a laminated structure of a solid-state imaging element according to a second modification example of the sixth embodiment.

FIG. 28 is a circuit diagram depicting a configuration example of a pixel according to the second modification example of the sixth embodiment.

FIG. 29 is a diagram depicting an example of a laminated structure of a solid-state imaging element according to a third modification example of the sixth embodiment.

FIG. 30 is a circuit diagram depicting a configuration example of a pixel according to a seventh embodiment.

FIG. 31 is a timing chart depicting an example of a global shutter operation according to the seventh embodiment.

FIG. 32 is a timing chart depicting an example of a global shutter operation for the odd frame according to an eighth embodiment.

FIG. 33 is a timing chart depicting an example of a read operation for the odd frame according to the eighth embodiment.

FIG. 34 is a timing chart depicting an example of a global shutter operation for the even frame according to the eighth embodiment.

FIG. 35 is a timing chart depicting an example of a read operation for the even frame according to the eighth embodiment.

FIG. 36 is a circuit diagram depicting a configuration example of a column signal processing circuit according to a ninth embodiment.

FIG. 37 is a timing chart depicting an example of a global shutter operation according to the ninth embodiment.

FIG. 38 is a timing chart depicting an example of a read operation according to the ninth embodiment.

FIG. 39 is a circuit diagram depicting a configuration example of a pixel according to a tenth embodiment.

FIG. 40 is a block diagram depicting a schematic configuration example of a vehicle control system.

FIG. 41 is an explanatory diagram depicting an example of an installation position of an imaging section.

### MODE FOR CARRYING OUT THE INVENTION

A mode for carrying out the present technology (hereinafter, referred to as an embodiment) will be described below. The description will be given in the following order.
1. First embodiment (example where normal image data and feature data are read in parallel)
2. Second embodiment (example where interface for outputting normal image data and interface for outputting feature data are separately provided)
3. Third embodiment (example where interface is used for outputting both normal image data and feature data)
4. Fourth embodiment (example where imaging device is responsible for performing arithmetic processing on feature data and controlling solid-state imaging element)
5. Fifth embodiment (example where normal image data and feature data are combined)
6. Sixth embodiment (example where post-stage reset transistor is added and first and second capacitor elements are caused to hold pixel signal)
7. Seventh embodiment (example where discharge transistor is added and first and second capacitor elements are caused to hold pixel signal)
8. Eighth embodiment (example where first and second capacitor elements are caused to hold pixel signal and a level to be held is changed for each frame)
9. Ninth embodiment (example where first and second capacitor elements are caused to hold pixel signal and pre-stage source follower is brought into off state at the time of reading)
10. Tenth embodiment (example where first capacitor element interposed between pre-stage node and ground terminal and second capacitor element interposed between pre-stage node and post-stage node are provided)
11. Example of application to mobile object

### 1. First Embodiment

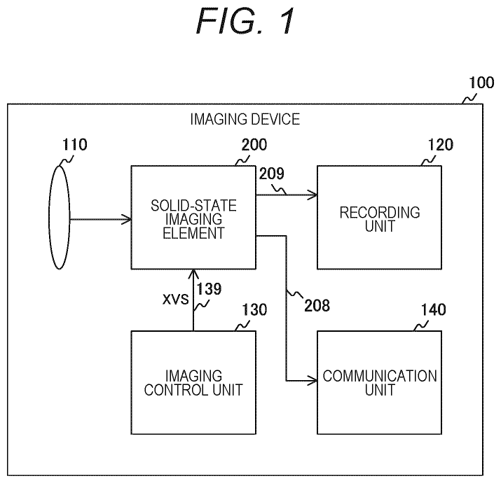

FIG. 1 is a block diagram depicting a configuration example of an imaging device according to a first embodiment.

In the drawing, an imaging device 100 generates image data and feature data on the basis of incident light. The imaging device 100 includes an imaging lens 110, a solid-state imaging element 200, a recording unit 120, an imaging control unit 130, and a communication unit 140. As the imaging device 100, a digital camera, or an electronic device (a smartphone, a personal computer, or the like) having an imaging function is assumed.

The solid-state imaging element 200 generates the image data and the feature data under the control of the imaging control unit 130. The solid-state imaging element 200 performs a global shutter operation (hereinafter, referred to as GS operation) using a sample-and-hold circuit and a rolling shutter operation (hereinafter, referred to as RS operation) in which the sample-and-hold circuit is skipped. A voltage-domain sample-and-hold circuit may be used. At this time, the solid-state imaging element 200 can generate normal image data on the basis of the GS operation and generate feature data on the basis of the RS operation. The feature data can include, for example, at least one of region of interest (ROI) image data, reduced image data, or phase difference data. At this time, data of some pixels can be read as the feature data.

The imaging lens 110 condenses incident light from a subject and guides the incident light to the solid-state imaging element 200. The imaging control unit 130 controls the solid-state imaging element 200 to generate the image data and the feature data. For example, the imaging control unit 130 supplies an imaging control signal including a vertical synchronization signal XVS to the solid-state imaging element 200 via a signal line 139. Note that the vertical synchronization signal XVS is a signal indicating imaging timing, and a periodic signal of a constant frequency (such as 60 hertz) is used as the vertical synchronization signal XVS.

The recording unit 120 records the image data. The recording unit 120 may be a non-volatile semiconductor storage device such as a solid state drivet (SSD) or a removable storage medium such as an SD card. The communication unit 140 transmits the feature data to the outside. The communication unit 140 may have a wireless communication function capable of using WiFi, a mobile phone network, or the like, or may have a near field communication function such as Bluetooth. Note that the imaging device 100 may include a display unit that displays the image data. The solid-state imaging element 200 supplies the image data to the recording unit 120 via a signal line 209. The solid-state imaging element 200 supplies the feature data to the communication unit 140 via a signal line 208.

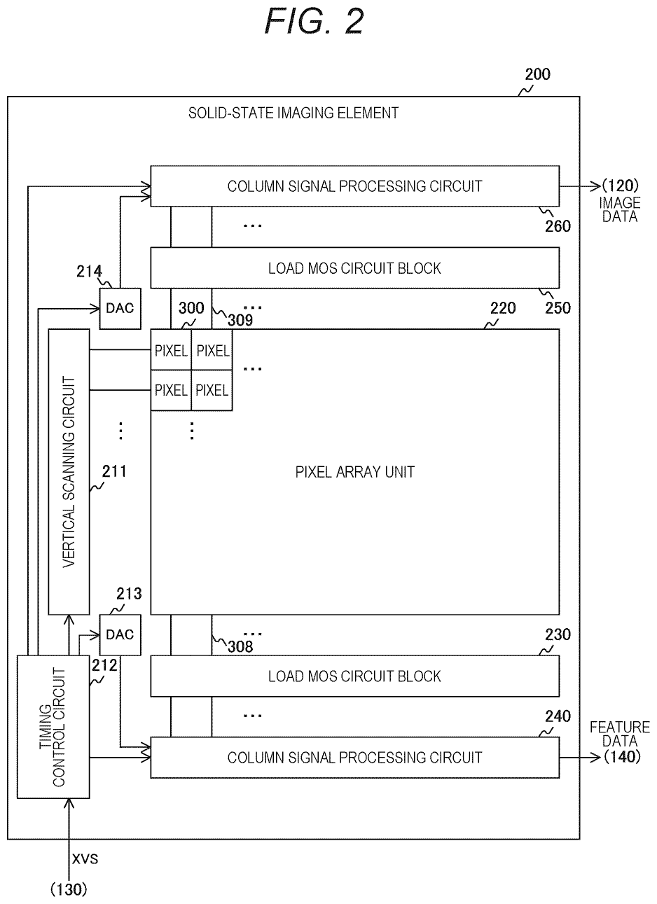

FIG. 2 is a block diagram depicting a configuration example of the solid-state imaging element according to the first embodiment.

In the drawing, the solid-state imaging element 200 includes a vertical scanning circuit 211, a pixel array unit 220, and a timing control circuit 212. In addition, the solid-state imaging element 200 includes vertical signal lines 308 and 309, digital to analog converters (DACs) 213 and 214, load MOS circuit blocks 230 and 250, and column signal processing circuits 240 and 260.

Hereinafter, a set of pixels 300 arranged in a horizontal direction is referred to as “row”, and a set of pixels 300 arranged in a direction orthogonal to the row is referred to as “column”.

In the pixel array unit 220, a plurality of the pixels 300 is arranged in a two-dimensional grid pattern. Each pixel 300 photoelectrically converts incident light to generate an analog pixel signal and feature data. Each pixel 300 includes a sample-and-hold circuit that holds a signal generated on the basis of charges read from a photoelectric conversion unit. Each pixel 300 is connected to the vertical signal lines 308 and 309 for each column. Each pixel 300 performs the GS operation using the sample-and-hold circuit and the RS operation in which the sample-and-hold circuit is skipped. In the RS operation, the sample-and-hold circuit is not used. Each pixel 300 outputs an image signal read on the basis of the GS operation to the vertical signal line 309, and outputs feature data read on the basis of the RS operation to the vertical signal line 308. The vertical signal line 309 transmits a signal output on the basis of the GS operation in the column direction. The vertical signal line 308 transmits a signal output on the basis of the RS operation in the column direction. Each circuit in the solid-state imaging element 200 is provided in, for example, a single semiconductor chip. Note that the vertical signal line 309 is an example of a first output unit described in the claims. The vertical signal line 308 is an example of a second output unit described in the claims.

The timing control circuit 212 controls operation timing of each of the vertical scanning circuit 211, the DACs 213 and 214, and the column signal processing circuits 240 and 260 in synchronization with the vertical synchronization signal XVS from the imaging control unit 130.

The DACs 213 and 214 each generate a sawtooth wave-like ramp signal by digital to analog (DA) conversion. The DAC 213 supplies the generated ramp signal to the column signal processing circuit 240, and the DAC 214 supplies the generated ramp signal to the column signal processing circuit 260.

The vertical scanning circuit 211 simultaneously exposes all the pixels 300 under the GS method and exposes the pixels row by row under the RS method. In addition, the vertical scanning circuit 211 selects and drives all the pixels 300 of the pixel array unit 220 to cause their respective sample-and-hold circuits to hold the analog pixel signal. In addition, the vertical scanning circuit 211 sequentially selects and drives a row of sample-and-hold circuits to cause the row to output the analog pixel signal held in the sample-and-hold circuits to the vertical signal line 309. In addition, the vertical scanning circuit 211 sequentially selects and drives a row in the pixel array unit 220 to cause the row to output the feature data generated on the basis of charges read from the corresponding photoelectric conversion units to the vertical signal line 308.

In each of the load MOS circuit blocks 230 and 250, a MOS transistor that supplies a constant current is provided for each column. The pixel signal output to the vertical signal line 309 is supplied to the column signal processing circuit 260 via the load MOS circuit block 250. The feature data output to the vertical signal line 308 is supplied to the column signal processing circuit 240 via the load MOS circuit block 230.

The column signal processing circuit 260 performs signal processing such as AD conversion processing and correlated double sampling (CDS) processing on the pixel signal for each column. The column signal processing circuit 260 supplies the image data including the processed signals to the recording unit 120. The column signal processing circuit 240 performs signal processing such as AD conversion processing and CDS processing on the feature data for each column. The column signal processing circuit 240 supplies the feature data including the processed signals to the communication unit 140.

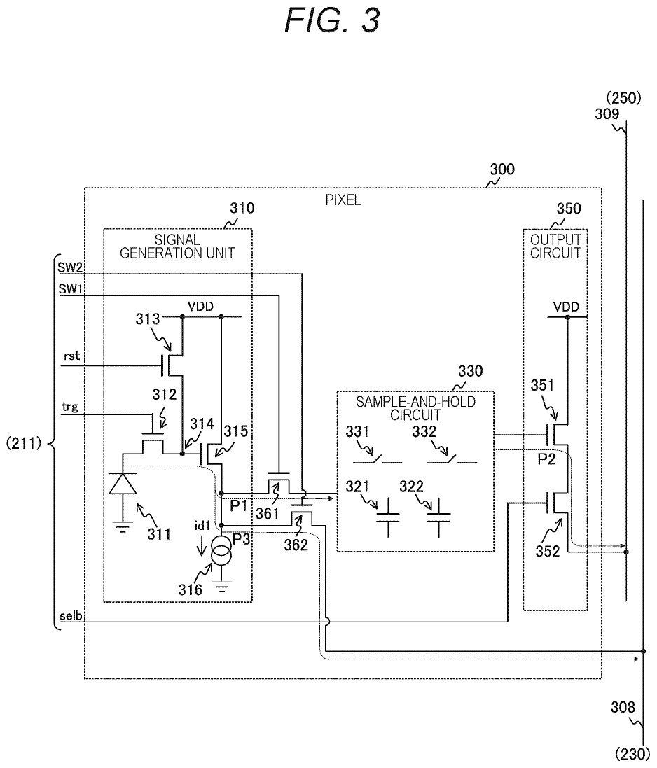

FIG. 3 is a diagram depicting a configuration example of the pixel according to the first embodiment.

In the drawing, the pixel 300 includes a signal generation unit 310, a global transistor 361, a rolling transistor 362, a sample-and-hold circuit 330, and an output circuit 350. Note that the global transistor 361 is an example of a first switch described in the claims. The rolling transistor 362 is an example of a second switch described in the claims.

The signal generation unit 310 generates a signal on the basis of charges read from the photoelectric conversion unit. The signal generation unit 310 includes a photoelectric conversion unit 311, a transfer transistor 312, a floating diffusion (FD) reset transistor 313, an FD 314, a pre-stage amplification transistor 315, and a current source transistor 316.

The photoelectric conversion unit 311 generates charges by photoelectric conversion. The photoelectric conversion unit 311 is, for example, a photodiode. The transfer transistor 312 transfers the charges from the photoelectric conversion unit 311 to the FD 314 in accordance with a transfer signal trg from the vertical scanning circuit 211.

The FD reset transistor 313 extracts the charges from the FD 314 to initialize the FD 314 in accordance with an FD reset signal rst from the vertical scanning circuit 211. The FD 314 accumulates charges, and generates a voltage corresponding to a charge amount. The pre-stage amplification transistor 315 generates a signal obtained by amplifying a voltage level of the FD 314.

In addition, the FD reset transistor 313 and the pre-stage amplification transistor 315 have their respective drains connected to a power supply voltage VDD. The current source transistor 316 is connected to a source of the pre-stage amplification transistor 315. The current source transistor 316 supplies a current id1 under the control of the vertical scanning circuit 211.

The global transistor 361 is connected between the signal generation unit 310 and the sample-and-hold circuit 330. The global transistor 361 is switched between on and off in accordance with a switching signal SW1 from the vertical scanning circuit 211. The rolling transistor 362 is connected between the signal generation unit 310 and the vertical signal line 308. The rolling transistor 362 is switched between on and off in accordance with a switching signal SW2 from the vertical scanning circuit 211.

The sample-and-hold circuit 330 holds the signal generated by the signal generation unit 310. The sample-and-hold circuit 330 includes capacitor elements 321 and 322 and switching transistors 331 and 332. The capacitor element 321 holds charges corresponding to a reset level of the FD 314. The capacitor element 322 holds charges corresponding to a signal level of the FD 314. The switching transistor 331 opens and closes a path between the capacitor element 321 and the output circuit 350. The switching transistor 332 opens and closes a path between the capacitor element 322 and the output circuit 350.

The output circuit 350 amplifies the signal held in the sample-and-hold circuit 330 and outputs the amplified signal to the vertical signal line 309. The output circuit 350 includes a post-stage amplification transistor 351, and a post-stage selection transistor 352. The post-stage amplification transistor 351 amplifies the signal held in the sample-and-hold circuit 330. The post-stage selection transistor 352 outputs the signal amplified by the post-stage amplification transistor 351 to the vertical signal line 309 as a pixel signal in accordance with a post-stage selection signal selb from the vertical scanning circuit 211.

Note that, for example, n-channel metal oxide semiconductor (nMOS) transistors are used as various transistors (transfer transistor 312 and the like) in the pixel 300.

Then, in the GS operation, when the global transistor 361 is switched on, the charges accumulated in the photoelectric conversion unit 311 during an exposure period after the global shutter are read from all the pixels and held in the sample-and-hold circuit 330 (P1). Then, when the switching transistor 331 is switched on, a signal corresponding to the reset level held in the capacitor element 321 is output to the vertical signal line 309 for each row. Thereafter, when the switching transistor 332 is switched on, a signal corresponding to the signal level held in the capacitor element 322 is output to the vertical signal line 309 for each row (P2).

On the other hand, in the RS operation, when the rolling transistor 362 is switched on, the charges accumulated in the photoelectric conversion unit 311 during the exposure period after the rolling shutter are read and output to the vertical signal line 308 for each row (P3). The exposure and the reading of the signal in the RS operation can be repeatedly performed during the reading of the signal from the sample-and-hold circuit 330 in the GS operation.

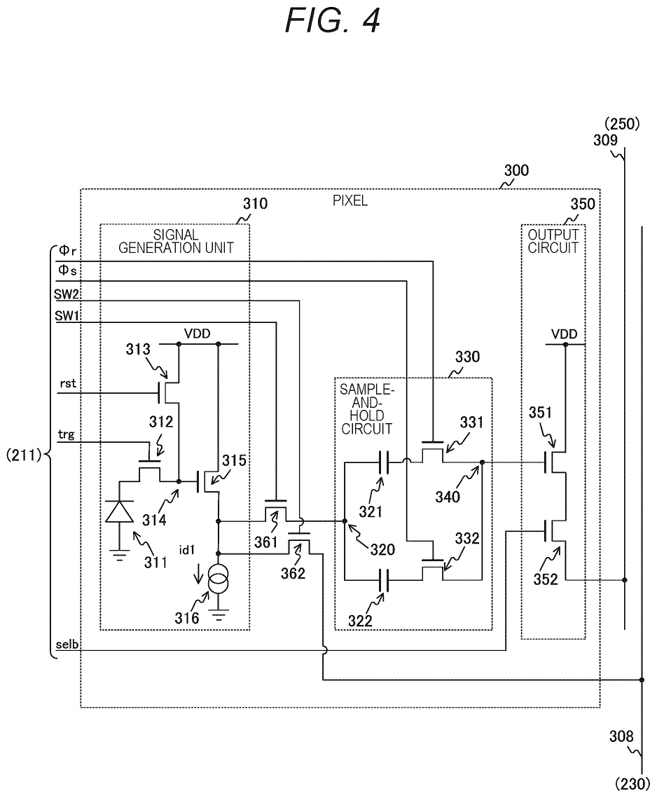

FIG. 4 is a diagram depicting a configuration example of the pixel circuit according to the first embodiment.

In the drawing, the sample-and-hold circuit 330 includes a pre-stage node 320 and a post-stage node 340. The pre-stage node 320 is connected to a source of the global transistor 361. The post-stage node 340 is connected to a gate of the post-stage amplification transistor 351. The capacitor elements 321 and 322 have their respective one ends connected to the pre-stage node 320. The capacitor elements 321 and 322 have their respective other ends connected to the post-stage node 340 via the switching transistors 331 and 332, respectively.

The switching transistor 331 opens and closes a path between the capacitor element 321 and the post-stage node 340 in accordance with a switching signal Ør from the vertical scanning circuit 211. The switching transistor 332 opens and closes a path between the capacitor element 322 and the post-stage node 340 in accordance with a switching signal φs from the vertical scanning circuit 211.

In the GS operation, the vertical scanning circuit 211 supplies a high-level FD reset signal rst and a high-level transfer signal trg to all the pixels at the start of exposure. As a result, the photoelectric conversion unit 311 is initialized, and exposure under the global shutter method is started simultaneously for all the pixels.

Then, the vertical scanning circuit 211 supplies, immediately before the end of exposure, the high-level FD reset signal rst over a pulse period while setting the switching signals φr and SW1 to the high level for all the pixels. As a result, the FD 314 is initialized, a level corresponding to the reset level of the FD 314 at that time is held in the capacitor element 321.

Next, the vertical scanning circuit 211 supplies, at the end of exposure, the high-level transfer signal trg over the pulse period while setting the switching signals φs and SW1 to the high level for all the pixels. As a result, signal charges corresponding to the exposure amount after the global shutter are transferred to the FD 314, and a level corresponding to the signal level of the FD 314 at that time is held in the capacitor element 322.

Next, the vertical scanning circuit 211 sequentially selects a row after the end of exposure to cause the corresponding sample-and-hold circuits 330 to sequentially output the reset level and the signal level of the row to the vertical signal line 309. In order to output the reset level, the vertical scanning circuit 211 supplies the high-level switching signal φr over a predetermined period while setting the post-stage selection signal selb of the selected row to the high level. As a result, the capacitor element 321 is connected to the post-stage node 340, and the reset level is sequentially read via the post-stage selection transistor 352 and the vertical signal line 309.

Next, in order to output the signal level, the vertical scanning circuit 211 supplies the high-level switching signal φs over the predetermined period while keeping the post-stage selection signal selb of the selected row at the high level. As a result, the capacitor element 322 is connected to the post-stage node 340, and the signal level is sequentially read via the post-stage selection transistor 352 and the vertical signal line 309.

On the other hand, in the RS operation, the vertical scanning circuit 211 supplies the high-level FD reset signal rst and the high-level transfer signal trg to the pixels of the same row at the start of exposure. As a result, the photoelectric conversion unit 311 is initialized, and exposure under the rolling shutter method is started for each row.

Then, the vertical scanning circuit 211 supplies, immediately before the end of exposure, the high-level FD reset signal rst over the pulse period while setting the switching signal SW2 to the high level for the pixels of the same row. As a result, the FD 314 is initialized, and a signal corresponding to the reset level of the FD 314 at that time is read via the vertical signal line 308 for each row.

Next, the vertical scanning circuit 211 supplies, at the end of exposure, the high-level transfer signal trg over the pulse period while setting the switching signal SW2 to the high level for the pixels of the same row. As a result, signal charges corresponding to the exposure amount after the rolling shutter are transferred to the FD 314, and a signal corresponding to the signal level of the FD 314 at that time is read via the vertical signal line 308 for each row.

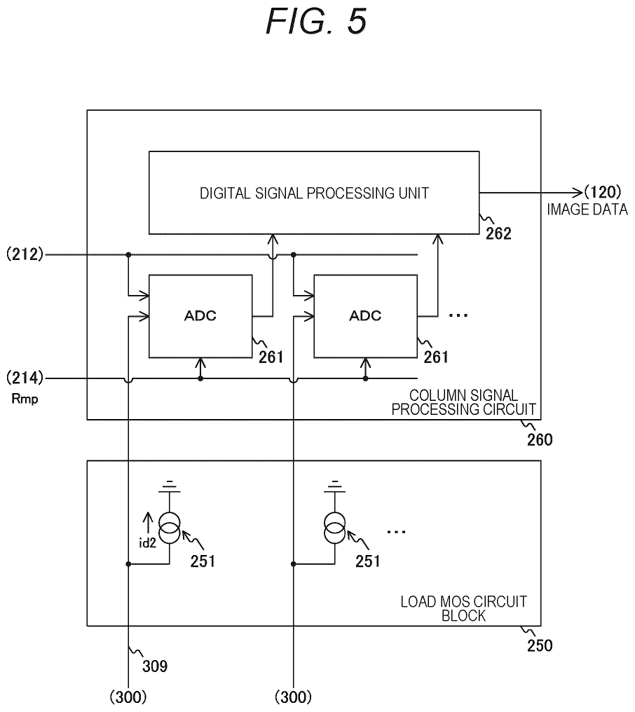

FIG. 5 is a block diagram depicting a configuration example of the load MOS circuit block 250 and the column signal processing circuit 260 according to the first embodiment.

In the load MOS circuit block 250, the vertical signal line 309 is wired for each column. In a case where the number of columns is I (I is an integer), I vertical signal lines 309 are wired. In addition, a load MOS transistor 251 that supplies a constant current id2 is connected to each of the vertical signal lines 309.

In the column signal processing circuit 260, a plurality of ADCs 261 and a digital signal processing unit 262 are arranged. The ADC 261 is arranged for each column. In a case where the number of columns is I, I ADCs 261 are arranged.

The ADC 261 converts an analog pixel signal from the corresponding column into a digital signal using a ramp signal Rmp from the DAC 214. The ADC 261 supplies the digital signal to the digital signal processing unit 262. For example, a single-slope ADC including a comparator and a counter is arranged as the ADC 261.

The digital signal processing unit 262 performs predetermined signal processing such as CDS processing on the digital signal for each column. The digital signal processing unit 262 supplies image data including the processed digital signals to the recording unit 120.

Note that the load MOS circuit block 230 and the column signal processing circuit 240 in FIG. 2 may be similar in configuration to the load MOS circuit block 250 and the column signal processing circuit 260. Note that, in the load MOS circuit block 230, the vertical signal line 308 is wired for each column. In a case where the number of columns is I, I vertical signal lines 308 are wired in the load MOS circuit block 230. Note that the ADC 261 provided in the column signal processing circuit 260 is an example of the first output unit described in the claims. The ADC provided in the column signal processing circuit 240 is an example of the second output unit described in the claims.

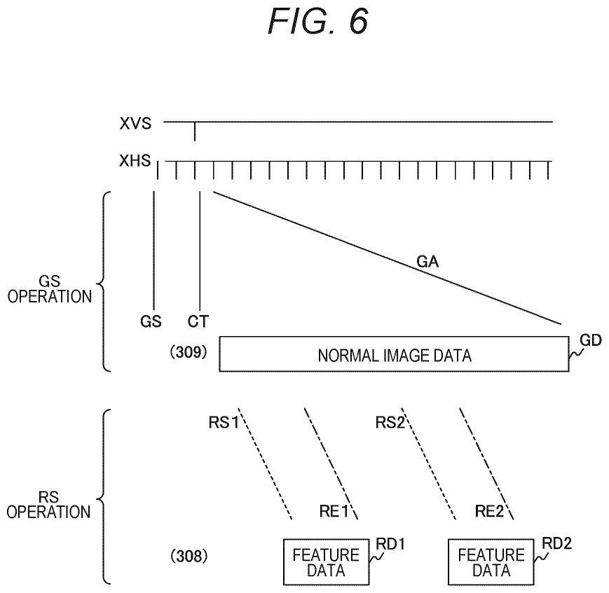

FIG. 6 is a diagram depicting an example of how the imaging device according to the first embodiment operates.

In the drawing, in the GS operation, the exposure of all the pixels is started at the timing of global shutter GS, and charges corresponding to the exposure amount are accumulated in the photoelectric conversion units 311 of all the pixels. Next, a signal corresponding to the charges accumulated in the photoelectric conversion unit 311 of each pixel is held in the sample-and-hold circuit 330 at timing of capacitance transfer CT. Next, the signal held in the sample-and-hold circuit 330 is sequentially read for each row at the timing of capacitance read GA, and is output to the vertical signal line 309 as normal image data GD.

On the other hand, in the RS operation, the exposure of each row is started at the timing of rolling shutter RS1 within the period of the capacitance read GA, and charges corresponding to the exposure amount are accumulated in the photoelectric conversion unit 311 of each pixel. Next, a signal corresponding to the charges accumulated in the photoelectric conversion unit 311 of each pixel is sequentially read for each row at the timing of rolling read RE1, and is output to the vertical signal line 308 as feature data RD1.

In addition, in the RS operation, rolling shutter RS2 is performed after the rolling shutter RS1 within the period of the capacitance read GA of the GS operation. At this time, the exposure of each row is started at the timing of the rolling shutter RS2, and charges corresponding to the exposure amount are accumulated in the photoelectric conversion unit 311 of each pixel. Next, a signal corresponding to the charges accumulated in the photoelectric conversion unit 311 of each pixel is read for row at the timing of rolling read RE2, and is output to the vertical signal line 308 as feature data RD2.

Note that the end timing of the rolling shutter RS2 may be after the end of the period of the capacitance read GA. In addition, in a case where imaging of two or more frames is performed, it is necessary to terminate the capacitance read and the exposure for the first frame under the rolling shutter method before the start timing of the global shutter for the second frame.

In addition, the feature data RD1 and RD2 may be different in type from each other or may be identical in type to each other. For example, both the feature data RD1 and RD2 may be reduced image data, the feature data RD1 and RD2 may be ROI image data and reduced image data, respectively, or the feature data RD1 and RD2 may be ROI image data and phase difference data, respectively.

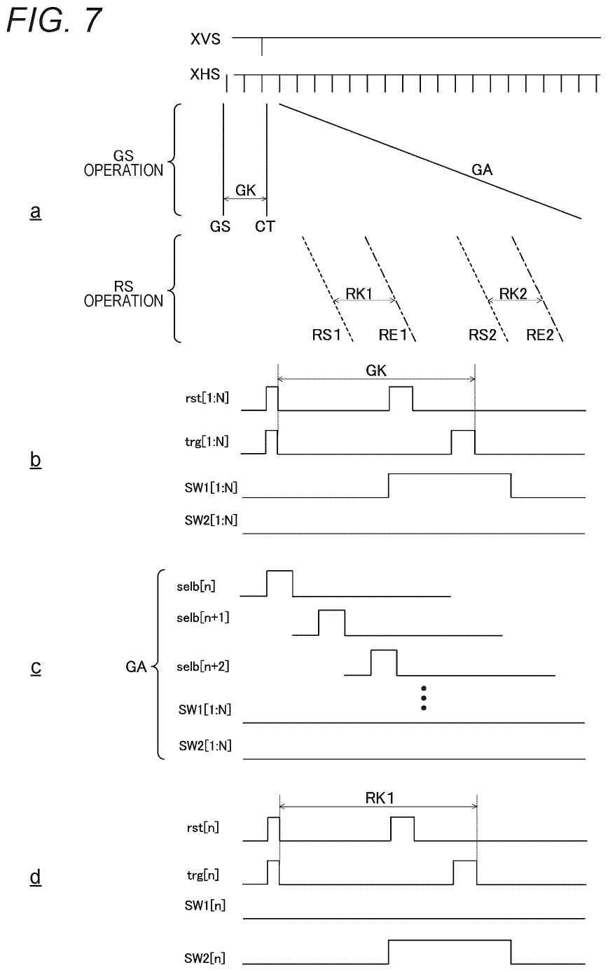

FIG. 7 is a timing chart depicting an example of a read operation of the imaging device according to the first embodiment. Note that, in the drawing, a is a diagram depicting the timing of the GS operation and the timing of the RS operation. In the drawing, b is a diagram depicting the exposure timing of the GS operation. In the drawing, c is a diagram depicting the read timing of the GS operation. In the drawing, d is a diagram depicting the exposure and read timing of the RS operation. Here, [n] in rst[n], trg[n], selb[n], and SW2[n] in the drawing represents pixels in the n-th row among the N rows. [1:N] in rst[1:N], trg[1:N], and SW1[1:N] represents pixels in the first to N-th rows. N is an integer indicating the total number of rows, and n is an integer from 1 to N.

As depicted in a and b of the drawing, in the GS operation, the vertical scanning circuit 211 supplies the high-level FD reset signal rst[1:N] and the transfer signal trg[1:N] to all the pixels at the start of an exposure period GK. At this time, the vertical scanning circuit 211 maintains the switching signals SW1[1:N] and SW2[1:N] at the low level for all the pixels. As a result, the photoelectric conversion unit 311 is initialized, and the exposure period GK in the GS operation is started.

Then, the vertical scanning circuit 211 supplies, immediately before the end of the exposure period GK, the high-level FD reset signal rst[1:N] over the pulse period while setting the switching signals or and SW1[1:N] to the high level for all the pixels. As a result, the FD 314 is initialized, and a signal corresponding to the reset level of the FD 314 at that time is held in the capacitor element 321.

Next, the vertical scanning circuit 211 supplies, at the end of the exposure period GK, the high-level transfer signal trg[1:N] over the pulse period while setting the switching signals φs and SW1[1:N] to the high level for all the pixels. As a result, signal charges corresponding to the exposure amount after the global shutter are transferred to the FD 314, and a signal corresponding to the signal level of the FD 314 at that time is held in the capacitor element 322.

Next, as depicted in a and c of the drawing, the vertical scanning circuit 211 sequentially selects a row after the end of the exposure period GK to cause the corresponding sample-and-hold circuits 330 to sequentially output the reset level and the signal level of the row to the vertical signal line 309. In order to output the reset level, the vertical scanning circuit 211 supplies the high-level switching signal φr over the predetermined period while setting the post-stage selection signal selb[n] of the selected row to the high level. At this time, the vertical scanning circuit 211 maintains the switching signals SW1[1:N] and SW2[1:N] at the low level for all the pixels. As a result, the capacitor element 321 is connected to the post-stage node 340, and the reset level is read to the vertical signal line 309.

Next, in order to output the signal level, the vertical scanning circuit 211 supplies the high-level switching signal φs over the predetermined period while keeping the post-stage selection signal selb[n] of the selected row at the high level. At this time, the vertical scanning circuit 211 maintains the switching signals SW1[1:N] and SW2[1:N] at the low level for all the pixels. As a result, the capacitor element 322 is connected to the post-stage node 340, and the signal level is read to the vertical signal line 309.

On the other hand, as depicted in a and d of the drawing, in the RS operation, the vertical scanning circuit 211 supplies, at the start of an exposure period RK1, the high-level FD reset signal rst[n] and the transfer signal trg[n] to the pixels of the same row. As a result, the photoelectric conversion unit 311 is initialized, and the exposure period RK1 is started for each row.

Then, the vertical scanning circuit 211 supplies, immediately before the end of the exposure period RK1, the high-level FD reset signal rst[n] over the pulse period while setting the switching signal SW2[n] to the high level for the pixels of the same row. As a result, the FD 314 is initialized, and a signal corresponding to the reset level of the FD 314 at that time is read to the vertical signal line 308 for each row.

Next, the vertical scanning circuit 211 supplies, at the end of the exposure period RK1, the high-level transfer signal trg[n] over the pulse period while setting the switching signal SW2[n] to the high level for the pixels of the same row. As a result, signal charges corresponding to the exposure amount during the exposure period RK1 are transferred to the FD 314, and a signal corresponding to the signal level of the FD 314 at that time is read to the vertical signal line 308 for each row.

The vertical scanning circuit 211 can operate in a similar manner during an exposure period RK2 after the exposure period RK1 within the period of the capacitance read GA of the GS operation.

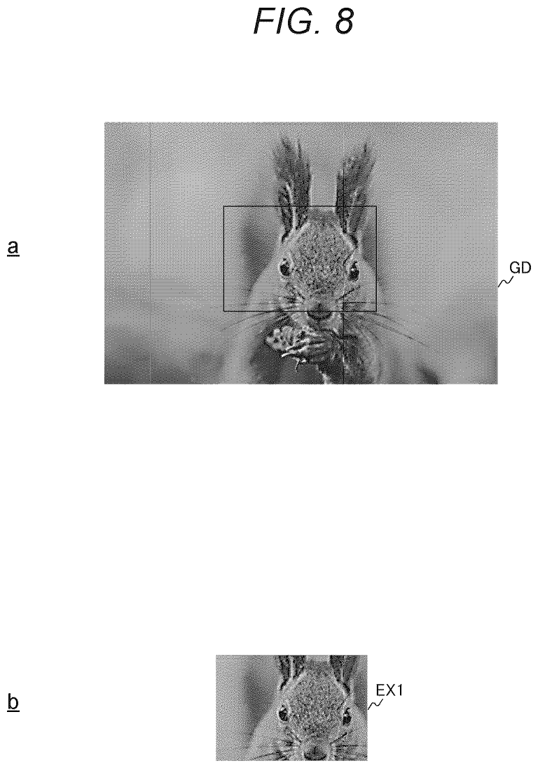

FIG. 8 is a diagram depicting the normal image data and a first example of the feature data according to the first embodiment. Note that a of the drawing depicts the normal image data GD, and b of the drawing depicts the first example of the feature data RD1.

In a of the drawing, the normal image data GD is, for example, full-pixel data. The normal image data GD can be generated on the basis of the GS operation. The normal image data GD may be still image data or moving image data. The normal image data GD can be used for viewing, for example.

In b of the drawing, the first example of the feature data RD1 is ROI image data EX1. b of the drawing depicts an example where a region enclosed by a black box in a of the drawing is set as the ROI. For the ROI image data EX1, the bit depth of AD conversion may be reduced. The ROI image data EX1 can be used for recognition or exposure adjustment, for example.

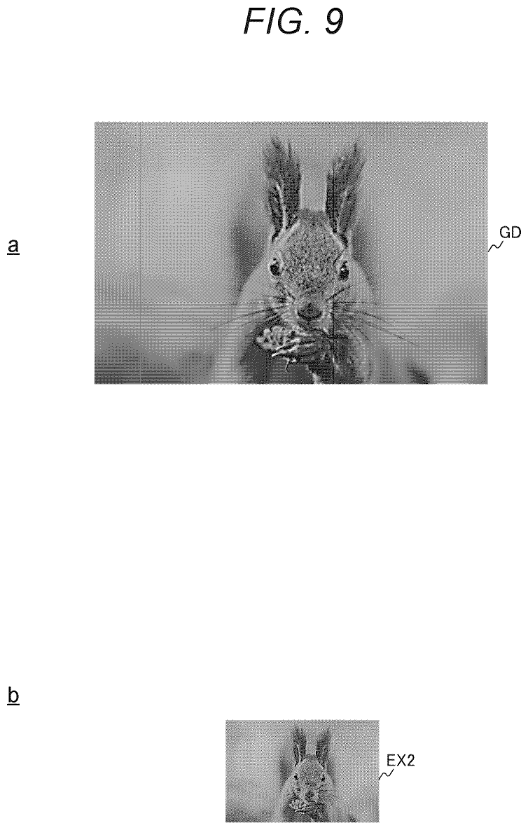

FIG. 9 is a diagram depicting the normal image data and a second example of the feature data according to the first embodiment. Note that a of the drawing depicts the normal image data GD, and b of the drawing depicts the second example of the feature data RD1.

The normal image data GD in a of the drawing is similar to the normal image data GD in a of FIG. 8.

In b of the drawing, the second example of the feature data RD1 is reduced image data EX2. An angle of view of the reduced image data EX2 may be the same as an angle of view of the normal image data GD. For the reduced image data EX2, the resolution of AD conversion may be reduced. The reduced image data EX2 can be used for recognition or motion detection, for example. The reduced image data EX2 may be used for live viewing.

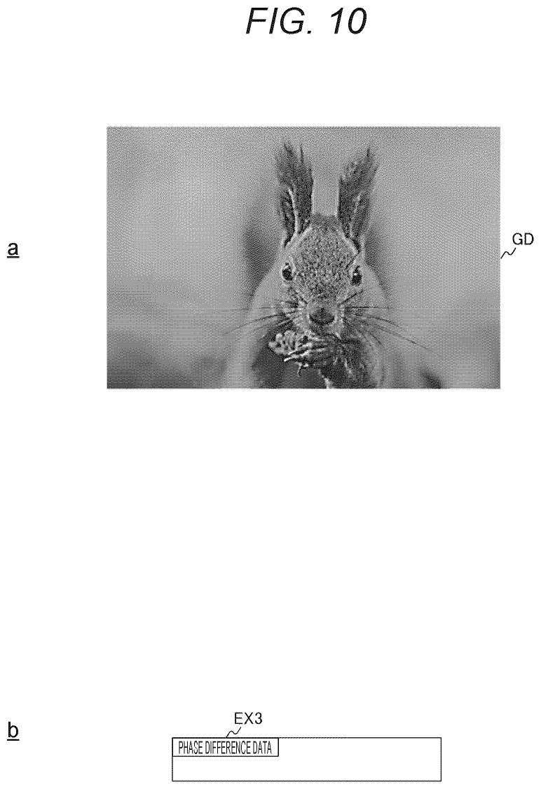

FIG. 10 is a diagram depicting the normal image data and a third example of the feature data according to the first embodiment. Note that a of the drawing depicts the normal image data GD, and b of the drawing depicts the third example of the feature data RD1.

The normal image data GD in a of the drawing is similar to the normal image data GD in a of FIG. 8.

In b of the drawing, the third example of the feature data RD1 is phase difference data EX3. The phase difference data EX3 can be used for depth information or focus adjustment, for example.

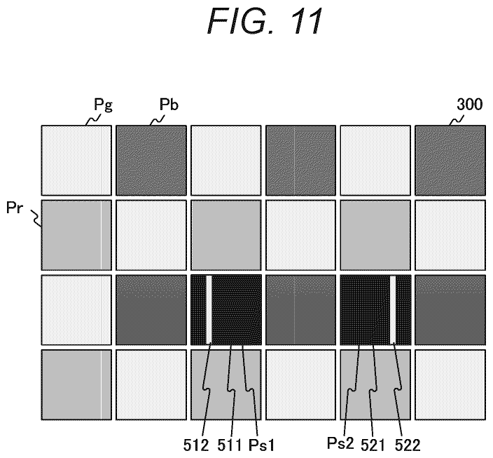

FIG. 11 is a diagram depicting an arrangement example of image plane phase difference pixels used for reading phase difference data according to the first embodiment.

As depicted in the drawing, the pixel array unit 220 includes the pixels 300 arranged in the row direction and the column direction. In the drawing, the Bayer array is taken as an example of the arrangement of the pixels 300. At this time, among 2×2 pixels 300 in the vertical and horizontal directions, green pixels Pg are arranged in the diagonal direction, and one blue pixel Pb and one red pixel Pr are arranged.

In addition, the pixel array unit 220 includes a pair of phase difference pixels Ps1 and Ps2 discretely arranged in the Bayer array. The phase difference pixels Ps1 and Ps2 are arranged close to each other in the pixel array unit 220. The phase difference pixels Ps1 and Ps2 are covered with light shielding films 511 and 521, respectively. The light shielding films 511 and 521 have slits 512 and 522 formed therein, respectively. The slits 512 and 522 are arranged away from each other.

In a case where the phase difference data is read as the feature data in the RS operation, it is only required that only the phase difference data of the phase difference pixels such as the phase difference pixels Ps1 and Ps2 be read. Note that a case where the phase difference data is not used as the feature data eliminates the need of the phase difference pixels Ps1 and Ps2. In addition, circuits of the phase difference pixels Ps1 and Ps2 are similar to the circuits of the other pixels (the circuit in FIG. 3). In addition, the phase difference pixels Ps1 and Ps2 are each provided with a color filter.

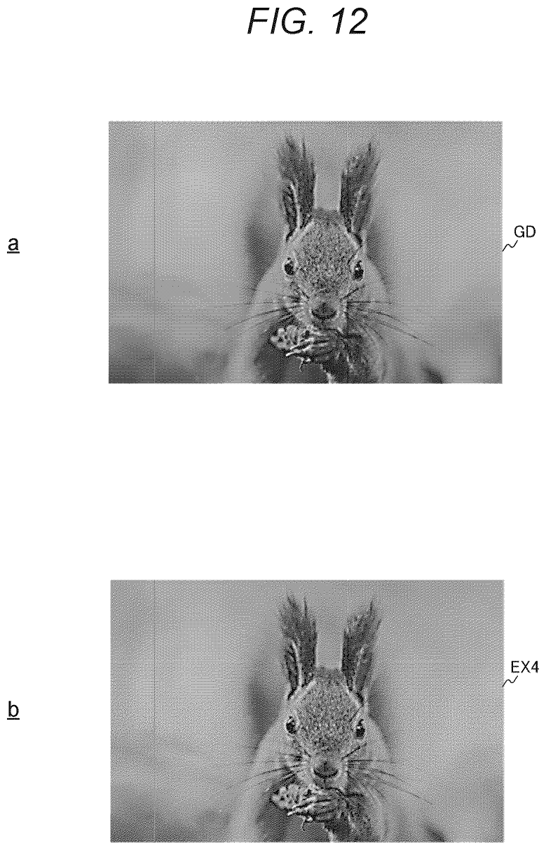

FIG. 12 is a diagram depicting the normal image data and a fourth example of the feature data according to the first embodiment. Note that a of the drawing depicts the normal image data GD, and d of the drawing depicts the fourth example of the feature data RD1.

The normal image data GD in a of the drawing is similar to the normal image data GD in a of FIG. 8.

In b of the drawing, the fourth example of the feature data RD1 is full-pixel data EX4. The full-pixel data EX4 may be still image data or moving image data. The full-pixel data EX4 can be used for recognition or motion detection, for example.

In the global shutter operation, normal image data GD without rolling shutter distortion can be generated. On the other hand, in the rolling shutter operation, the full-pixel data EX4 that is less in noise and higher in dynamic range than the normal image data GD can be generated. Therefore, the normal image data GD may be used as a moving image, and the full-pixel data EX4 may be used as a still image.

As described above, in the first embodiment described above, the vertical signal line 309 that outputs the normal image data GD and the vertical signal line 308 that outputs the feature data RD1 and RD2 are separately provided. With this configuration, the feature data RD1 and RD2 can be read in parallel with the normal image data GD, and a plurality of pieces of feature data RD1 and RD2 can be acquired within the same vertical synchronization period. It is therefore possible to improve real-time performance of the feature data RD1 and RD2, improve imaging trackability of a moving image, or improve recognition and detection accuracy.

### 2. Second Embodiment

In the first embodiment described above, the vertical signal line 309 that outputs the normal image data GD and the vertical signal line 308 that outputs the feature data RD1 and RD2 are separately provided in the solid-state imaging element 200. In the second embodiment, an interface for outputting the normal image data GD and an interface for outputting the feature data RD1 and RD2 are separately provided in the imaging device.

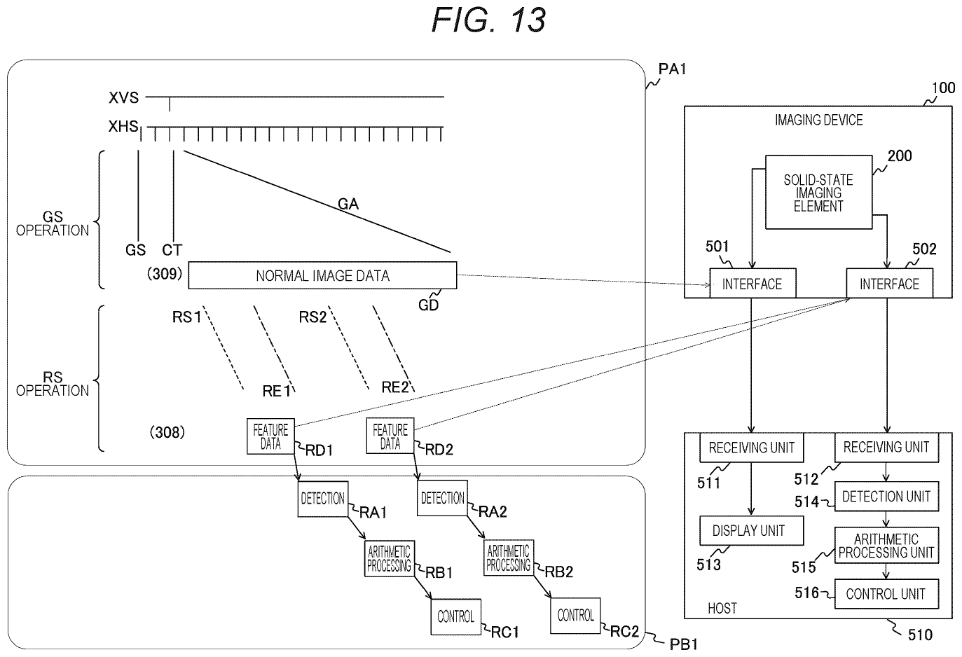

FIG. 13 is a diagram depicting an example of a configuration and an operation of an image processing device according to the second embodiment.

As depicted in the drawing, the image processing device includes an imaging device 100 and a host 510. The imaging device 100 includes interfaces 501 and 502 as the communication unit 140 in FIG. 1. The interface 501 converts the normal image data GD into a data format that the host 510 can receive and transmits the resultant data to the host 510. The interface 502 converts the feature data RD1 and RD2 into a data format that the host 510 can receive and transmits the resultant data to the host 510.

The host 510 receives the normal image data GD and the feature data RD1 and RD2 transmitted from the imaging device 100. The host 510 may be a personal computer or a cloud computer. The host 510 may be a portable digital assistant such as a smartphone including the imaging device 100 incorporated therein. The host 510 may be used in a WEB conference camera or a surveillance camera.

The host 510 includes receiving units 511 and 512, a display unit 513, a detection unit 514, an arithmetic processing unit 515, and a control unit 516.

The receiving unit 511 receives the normal image data GD from the imaging device 100. The receiving unit 512 receives the feature data RD1 and RD2 from the imaging device 100. The display unit 513 displays the normal image data GD received by the receiving unit 511. The detection unit 514 detects the feature data RD1 and RD2 received by the receiving unit 512. The detection is, for example, processing of extracting depth information from the phase difference data. The arithmetic processing unit 515 performs arithmetic processing on the feature data RD1 and RD2 received by the receiving unit 512. Examples of the arithmetic processing include object recognition processing such as obstacle recognition, lane recognition, sign recognition, and pedestrian detection, motion vector detection processing, and detection processing of detecting luminance information. The control unit 516 controls an external device on the basis of the feature data RD1 and RD2. Examples of the external device include an authentication device and a mobile object such as an automobile, a vessel, an aircraft, a drone, or a robot. Examples of the control include drive control of a mobile object for avoiding an obstacle, access control based on face authentication, and selection control based on quality of an agricultural product or a product.

Here, the imaging device 100 performs processing PA1 to transmit the feature data RD1 and RD2 to the host 510 via the interface 502 in parallel with the transmission of the normal image data GD to the host 510 via the interface 501.

The host 510 performs processing PB1 to receive the plurality of pieces of feature data RD1 and RD2 together with the normal image data GD from the imaging device 100. Then, the host 510 sequentially performs detection RA1, arithmetic processing RB1, and control RC1 on the feature data RD1, and sequentially performs detection RA2, arithmetic processing RB2, and control RC2 on the feature data RD2. It is therefore possible for the host 510 to improve real-time performance of the control RC1 and RC2, and improve accuracy of the control RC1 and RC2.

As described above, in the second embodiment described above, the interface 501 that outputs the normal image data GD and the interface 502 that outputs the feature data RD1 and RD2 are separately provided in the imaging device 100. It is therefore possible for the host 510 to receive the plurality of pieces of feature data RD1 and RD2 from the imaging device 100 together with the normal image data GD and improve real-time performance of the control RC1 and RC2 without deteriorating the quality of the normal image data GD.

### 3. Third Embodiment

In the second embodiment described above, the interface 501 that outputs the normal image data GD and the interface 502 that outputs the feature data RD1 and RD2 are separately provided in the imaging device 100. In the third embodiment, an interface used for both the output of the normal image data GD and the output of the feature data RD1 and RD2 is provided in the imaging device, and the normal image data GD and the feature data RD1 and RD2 are output in a time-division manner.

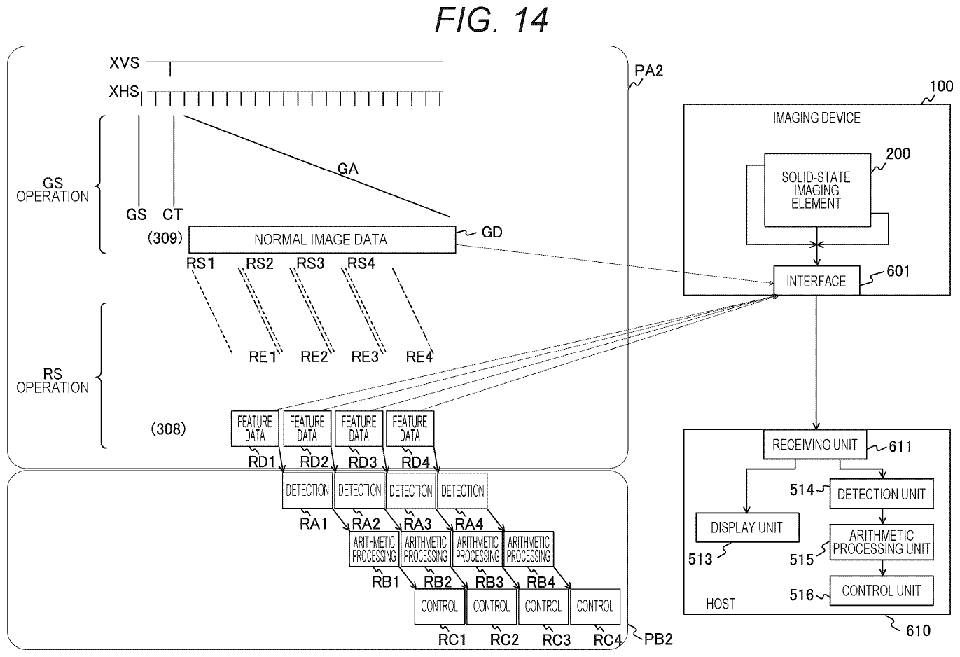

FIG. 14 is a diagram depicting an example of a configuration and an operation of an image processing device according to the third embodiment.

As depicted in the drawing, the image processing device includes an imaging device 100 and a host 610. The imaging device 100 includes an interface 601 as the communication unit 140 in FIG. 1. The interface 601 converts the normal image data GD and feature data RD1 to RD4 into a data format that the host 610 can receive, and transmits the resultant data to the host 610 in a time-division manner.

The host 610 includes a receiving unit 611 instead of the receiving units 511 and 512 of the second embodiment described above. The receiving unit 611 receives the normal image data GD and the feature data RD1 to RD4 from the imaging device 100 in a time-division manner. Other configurations of the host 610 of the third embodiment are similar to those of the host 510 of the second embodiment described above.

Here, the imaging device 100 performs processing PA2 to transmit, in a time-division manner, the normal image data GD and the feature data RD1 to RD4 to the host 610 via the interface 601.

The host 610 performs processing PB2 to receive the plurality of pieces of feature data RD1 to RD4 together with the normal image data GD from the imaging device 100. Then, the host 610 can sequentially performs detection RA1 to RA4, arithmetic processing RB1 to RB4, and control RC1 to RC4 on the respective pieces of feature data RD1 to RD4. It is therefore possible for the host 610 to improve real-time performance of the control RC1 to RC4 and improve accuracy of the control RC1 to RC4 without deteriorating the quality of the normal image data GD.

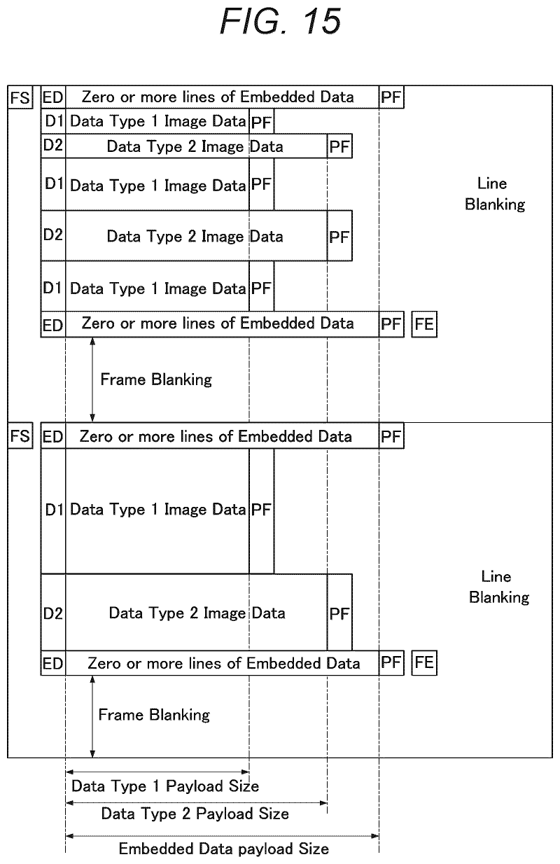

FIG. 15 is a diagram depicting an example of a format used when the image processing device according to the third embodiment transmits data. Note that, in the drawing, a mobile industry processor interface (MIPI) is taken as an example of the format when the normal image data GD and the feature data RD1 and RD2 are transmitted in a time-division manner.

In the drawing, the feature data RD1 and RD2 can be transmitted as ‘Data Type 1 Image Data’, and the normal image data GD can be transmitted as ‘Data Type 2 Image Data’.

Note that FS stands for Frame Start. FE stands for Frame End. ED stands for Packet Header containing Embedded Data type code. D1 stands for Packet Header containing Data Type 1 Image Data code. D2 stands for Packet Header containing Data Type 2 Image Data code. PF stands for Packet Footer+Filler (if applicable).

As described above, in the third embodiment described above, the interface 601 is used for both the output of the normal image data GD and the output of the feature data RD1 and RD2, and the normal image data GD and the feature data RD1 and RD2 are output in a time-division manner. It is therefore possible for the host 510 to receive the plurality of pieces of feature data RD1 and RD2 from the imaging device 100 together with the normal image data GD and improve real-time performance of the controls RC1 and RC2 while suppressing an increase in circuit scale.

### 4. Fourth Embodiment

In the second embodiment described above, the host 510 performs arithmetic processing on the feature data RD1 and RD2 and controls the external device. In the fourth embodiment, the imaging device performs arithmetic processing on the feature data, controls the solid-state imaging element 200, and transmits, to the host, the result of the arithmetic processing performed on the feature data.

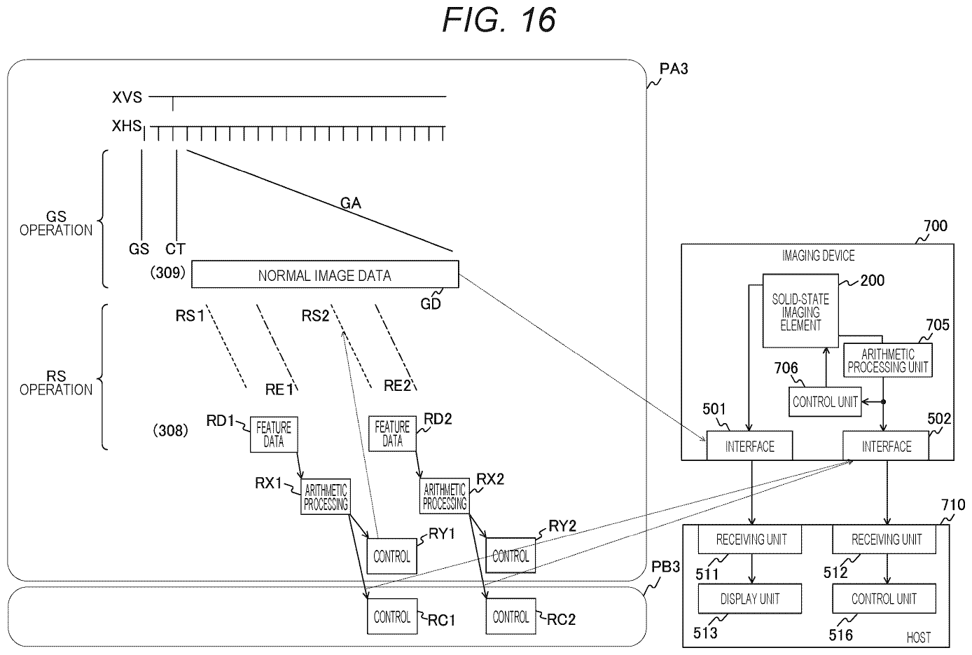

FIG. 16 is a diagram depicting an example of a configuration and an operation of an image processing device according to the fourth embodiment.

As depicted in the drawing, the image processing device includes an imaging device 700 and a host 710. The imaging device 700 includes an arithmetic processing unit 705 and a control unit 706 in addition to the components of the imaging device 100 of the second embodiment described above. Other configurations of the imaging device 700 of the fourth embodiment are similar to those of the imaging device 100 of the second embodiment described above.

The arithmetic processing unit 705 performs arithmetic processing on the feature data RD1 and RD2 output from the solid-state imaging element 200. The control unit 706 controls the solid-state imaging element 200 on the basis of the result of the arithmetic processing performed on the feature data RD1 and RD2. Examples of the control of the solid-state imaging element 200 include exposure control, focus control, zoom control, and ROI control. The control of the solid-state imaging element 200 may be control based on the global shutter operation or control based on the rolling shutter operation.

The host 710 includes the components the host 510 of the second embodiment described above except the detection unit 514 and the arithmetic processing unit 515. Other configurations of the host 710 of the fourth embodiment are similar to those of the host 510 of the second embodiment described above.

Here, the imaging device 100 performs processing PA3 to sequentially perform arithmetic processing RX1 and control RY1 on the feature data RD1 and sequentially perform arithmetic processing RX2 and control RY2 on the feature data RD2.

For example, it is assumed that the feature data RD1 and RD2 are ROI image data. At this time, in the arithmetic processing RX1, the brightness of the ROI image data may be detected from the feature data RD1, and in the control RY1, the timing of the rolling shutter RS2 for the feature data RD2 may be controlled on the basis of the result of the detection of the brightness of the feature data RD1. At this time, a plurality of pieces of ROI image data different in brightness from each other can be acquired, thereby allowing an increase in dynamic range of the ROI image data.

Alternatively, it is assumed that the feature data RD1 is reduced image data, and the feature data RD2 is ROI image data. At this time, a moving object may be detected on the basis of the feature data RD1, and an ROI of the feature data RD2 may be designated so as to include the moving object.

Alternatively, it is assumed that the feature data RD1 and RD2 are phase difference data. At this time, a phase difference is detected by means of the detection of each piece of feature data RD1 and RD2, and each phase difference is converted into a focusing position by corresponding arithmetic processing RX1 or RX2. Then, in the control RY1 and RY2, a lens can be moved for each focusing position calculated on the basis of the corresponding feature data RD1 or RD2.

In addition, the imaging device 700 transmits the result of the arithmetic processing performed on the feature data RD1 and RD2 to the host 710 via the interface 502 in parallel with the transmission of the normal image data GD to the host 710 via the interface 501.

The host 710 performs processing PB3 to receive the result of the arithmetic processing performed on the plurality of pieces of feature data RD1 and RD2 together with the normal image data GD from the imaging device 700. Then, the host 710 can perform control RC1 on the basis of the result of the arithmetic processing performed on the feature data RD1 and perform control RC2 on the basis of the result of the arithmetic processing performed on the feature data RD2. It is therefore possible for the host 710 to improve real-time performance of the control RC1 and RC2 and improve accuracy of the control RC1 and RC2 while reducing a load applied to the arithmetic processing performed on the feature data RD1 and RD2.

As described above, in the fourth embodiment described above, the imaging device 700 performs the arithmetic processing on the feature data RD1 and RD2, controls the solid-state imaging element 200, and transmits, to the host 710, the result of the arithmetic processing performed on the feature data. It is therefore possible for the imaging device 700 to improve real-time performance of the control of the solid-state imaging element 200 and improve real-time performance of the control of the external device by the host 710 while reducing a load applied to the arithmetic processing in the host 710.

### 5. Fifth Embodiment

In the first embodiment described above, in order to output the normal image data GD and the feature data RD1 and RD2 in parallel, the vertical signal line 309 that outputs the normal image data GD and the vertical signal line 308 that outputs the feature data RD1 and RD2 are separately provided. In the fifth embodiment, a combining unit that combines at least one of the feature data RD1 or the feature data RD2 and the normal image data GD is provided in the host.

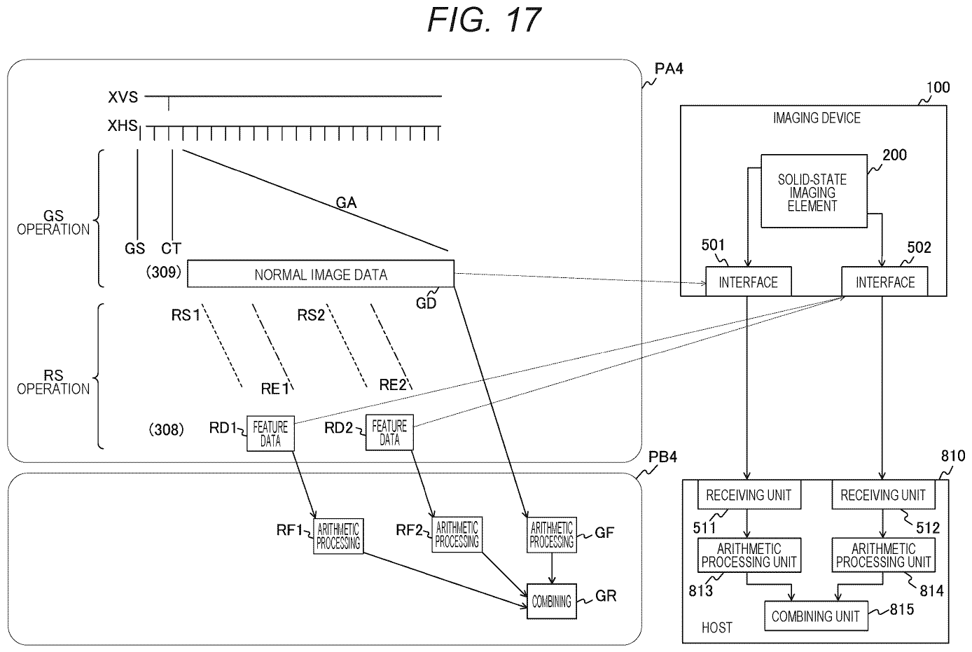

FIG. 17 is a diagram depicting an example of a configuration and an operation of an image processing device according to the fifth embodiment.

As depicted in the drawing, the image processing device includes an imaging device 100 and a host 810. The host 810 receives the normal image data GD and the feature data RD1 and RD2, and combines at least one of the feature data RD1 or the feature data RD2 and the normal image data GD.

The host 810 includes receiving units 511 and 512, arithmetic processing units 813 and 814, and a combining unit 815. The arithmetic processing unit 813 performs arithmetic processing on the normal image data GD. The arithmetic processing unit 814 performs arithmetic processing on the feature data RD1 and RD2. The combining unit 815 combines at least one of the feature data RD1 or the feature data RD2 and the normal image data GD on the basis of the result of the arithmetic processing performed on the normal image data GD and the feature data RD1 and RD2.

Here, the imaging device 100 performs processing PA4 to transmit the normal image data GD to the host 810 via the interface 501 and transmit the feature data RD1 and RD2 to the host 810 via the interface 502.

The host 810 performs processing PB4 to receive the normal image data GD and the feature data RD1 and RD2 from the imaging device 100. Then, the host 810 performs arithmetic processing RF1 on the feature data RD1, performs arithmetic processing RF2 on the feature data RD2, and performs arithmetic processing GF on the normal image data GD. Then, the host 810 can perform combining GR of at least one of the feature data RD1 or the feature data RD2 and the normal image data GD on the basis of the result of the arithmetic processing.

For example, it is assumed that the feature data RD1 is reduced image data, and the feature data RD2 is ROI image data. At this time, the feature data RD2 may be used for an ROI portion of the normal image data GD, and the feature data RD1 may be used for a background portion of the normal image data GD.

As described above, in the fifth embodiment described above, the combining unit 815 that combines at least one of the feature data RD1 or the feature data RD2 and the normal image data GD is provided. It is therefore possible to improve imaging trackability of a moving image while reducing rolling shutter distortion, and it is also possible to improve image quality for a stationary subject.

Hereinafter, a modification example of the GS operation using the voltage-domain sample-and-hold circuit 330 will be described.

### 6. Sixth Embodiment

In the first embodiment described above, the sample-and-hold circuit 330 is provided with the post-stage node 340 to which the switching transistors 331 and 332 are both connected. In the sixth embodiment, a post-stage reset transistor is connected to the post-stage node 340 to which the switching transistors 331 and 332 are both connected.

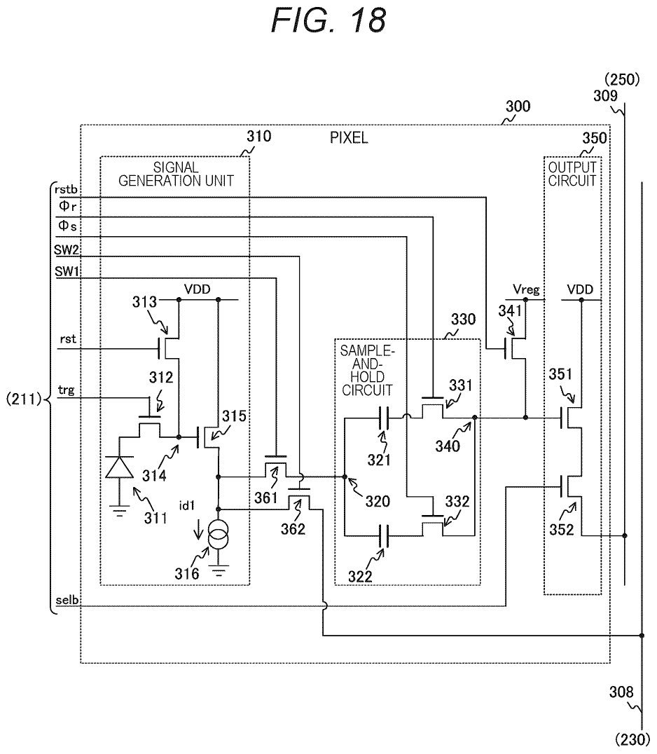

FIG. 18 is a circuit diagram depicting a configuration example of a pixel 300 according to the sixth embodiment.

The pixel 300 of the sixth embodiment includes a post-stage reset transistor 341 in addition to the components of the pixel 300 of the first embodiment described above. Other configurations of the pixel 300 of the sixth embodiment are similar to those of the pixel 300 of the first embodiment described above.

The post-stage reset transistor 341 is connected between a potential Vreg and the post-stage node 340. The post-stage reset transistor 341 initializes a level of the post-stage node 340 to the predetermined potential Vreg in accordance with a post-stage reset signal rstb from the vertical scanning circuit 211. A potential different from the power supply potential VDD (for example, a potential lower than VDD) is set as the potential Vreg.

The vertical scanning circuit 211 supplies the high-level FD reset signal rst and the high-level transfer signal trg to all the pixels at the start of exposure. As a result, the photoelectric conversion unit 311 is initialized. Hereinafter, this control is referred to as “PD reset”.

Then, the vertical scanning circuit 211 supplies, immediately before the end of exposure, the high-level FD reset signal rst over the pulse period while setting the post-stage reset signal rstb and the switching signals Ør and SW1 to the high level for all the pixels. As a result, the FD 314 is initialized, a level corresponding to the reset level of the FD 314 at that time is held in the capacitor element 321. This control is hereinafter referred to as “FD reset”.

The reset level of the FD 314 at the time of the FD reset and a level corresponding to the rest level (the level held in the capacitor element 321 and the level of the vertical signal line 309) are hereinafter collectively referred to as “P-phase” or “reset level”.

Next, the vertical scanning circuit 211 supplies, at the end of exposure, the high-level transfer signal trg over the pulse period while setting the post-stage reset signal rstb and the switching signals φs and SW1 to the high level for all the pixels. As a result, signal charges corresponding to the exposure amount are transferred to the FD 314, and a level corresponding to the signal level of the FD 314 at that time is held in the capacitor element 322.

The level of the FD 314 at the time of the signal charge transfer and a level corresponding to the signal level of the FD 314 (the level held in the capacitor element 322 and the level of the vertical signal line 309) are hereinafter collectively referred to as “D-phase” or “signal level”.

Next, the vertical scanning circuit 211 sequentially selects a row after the end of exposure, and sequentially outputs the reset level and the signal level of the row. In order to output the reset level, the vertical scanning circuit 211 supplies the high-level switching signal φr over a predetermined period while setting the post-stage selection signal selb of the selected row to the high level. As a result, the capacitor element 321 is connected to the post-stage node 340, and the reset level is read to the vertical signal line 309 via the post-stage selection transistor 352.

Next, the vertical scanning circuit 211 supplies, after the readout of the reset level, the high-level post-stage reset signal rstb over the pulse period while keeping the post-stage selection signal selb of the selected row at the high level. As a result, the level of the post-stage node 340 is initialized. At this time, both the switching transistors 331 and 332 are in the open state, and the capacitor elements 321 and 322 are disconnected from the post-stage node 340.

Next, the vertical scanning circuit 211 supplies, after the initialization of the post-stage node 340, the high-level switching signal Øs over a predetermined period while keeping the post-stage selection signal selb of the selected row at the high level. As a result, the capacitor element 322 is connected to the post-stage node 340, and the signal level is read to the vertical signal line 309 via the post-stage selection transistor 352.

Under the above-described read control, the sample-and-hold circuit 330 of the selected row sequentially performs control to connect the capacitor element 321 to the post-stage node 340, control to disconnect the capacitor elements 321 and 322 from the post-stage node 340, and control to connect the capacitor element 322 to the post-stage node 340. In addition, when the capacitor elements 321 and 322 are disconnected from the post-stage node 340, the post-stage reset transistor 341 of the selected row initializes the level of the post-stage node 340. In addition, the output circuit 350 of the selected row sequentially read the reset level and the signal level from the capacitor elements 321 and 322 via the post-stage node 340, and output the reset level and the signal level to the vertical signal line 309.

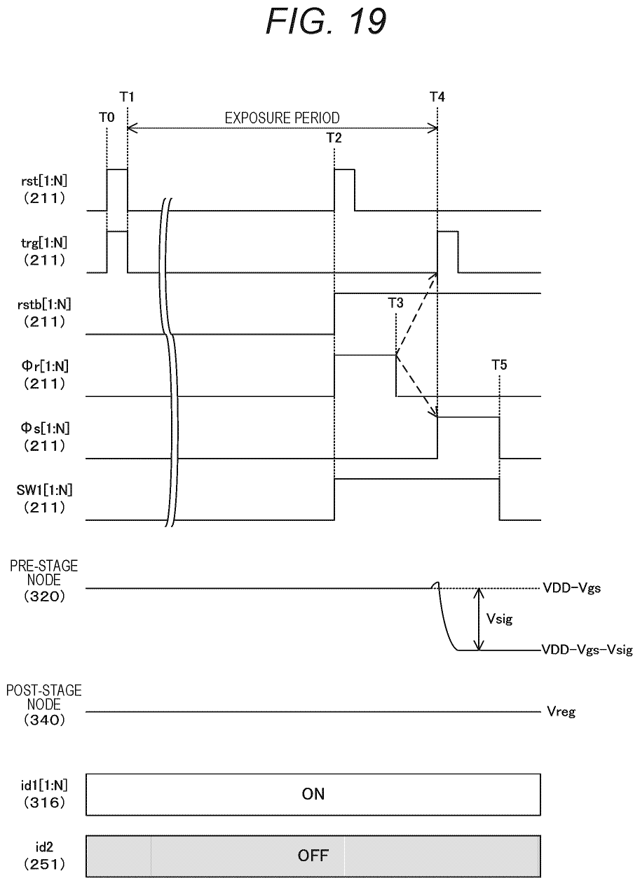

FIG. 19 is a timing chart depicting an example of a global shutter operation according to the sixth embodiment. The vertical scanning circuit 211 supplies the high-level FD reset signal rst[1:N] and the high-level transfer signal trg[1:N] to all the rows (in other words, all pixels) over a period from timing T0 immediately before the start of exposure to timing T1 that is the end of the pulse period. As a result, all the pixels are PD reset, and the exposure is simultaneously started in all the rows.

Then, the vertical scanning circuit 211 supplies, at timing T2 immediately before the end of the exposure period, the high-level FD reset signal rst[1:N] over the pulse period while setting the post-stage reset signal rstb [1:N] and the switching signals or [1:N] and SW1[1:N] to the high level for all the pixels. As a result, all the pixels are FD reset, and the reset level is sampled and held.

Next, the vertical scanning circuit 211 returns the switching signal φr [1:N] to the low level at timing T3 after timing T2.

Next, the vertical scanning circuit 211 supplies, at timing T4 that is the end of exposure, the high-level transfer signal trg[1:N] over the pulse period while setting the post-stage reset signal rstb [1:N] and the switching signals φs [1:N] and SW1[1:N] to the high level for all the pixels. As a result, the signal level is sampled and held. In addition, the level of the pre-stage node 320 decreases from the reset level (VDD−Vgs) to the signal level (VDD−Vgs−Vsig). Here, VDD indicates a power supply voltage, and Vsig indicates a net signal level obtained as a result of the CDS processing. Vgs indicates a gate-source voltage of the pre-stage amplification transistor 315.

Next, the vertical scanning circuit 211 returns the switching signals φs [1:N] and SW1[1:N] to the low level at timing T5 after timing T4.

In addition, the vertical scanning circuit 211 controls the current source transistors 316 of all the rows (all the pixels) to supply the current id1 [1:N]. The larger the current id [1:N], the larger IR drop becomes, so that it is required that the current id1 [1:N] be on the order of several nanoamperes (nA) to several tens of nanoamperes (nA). On the other hand, the load MOS transistors 251 of all the columns are in the off state, and the current id2 is not supplied to the vertical signal line 309.

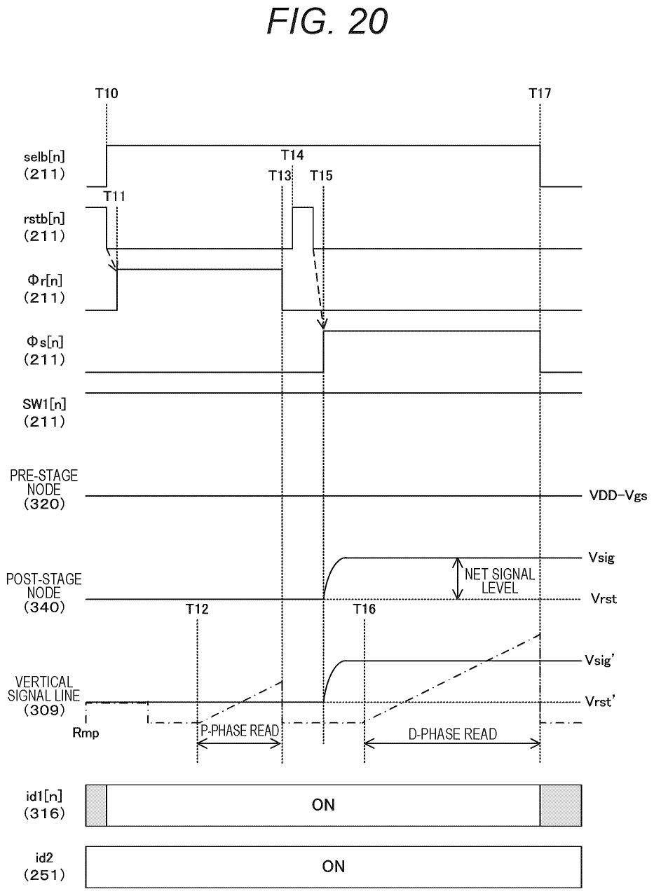

FIG. 20 is a timing chart depicting an example of a read operation according to the sixth embodiment. Over a read period of the n-th row from timing T10 to timing T17, the vertical scanning circuit 211 sets the post-stage selection signal selb[n] of the n-th row to the high level. In addition, over the read period, the vertical scanning circuit 211 sets switching signal SW1[n] of the n-th row to the low level.

The vertical scanning circuit 211 changes, at timing T10, the post-stage reset signal rstb [n] of the n-th row from the high level to the low level.

Next, the vertical scanning circuit 211 supplies the high-level switching signal φr [n] to the n-th row over a period from timing T11 immediately after timing T10 to timing T13. The potential of the post-stage node 340 becomes the reset level Vrst.

In addition, the DAC 214 gradually increases the level of the ramp signal Rmp over a period from timing T12 after timing T11 to timing T13. The ADC 261 compares the ramp signal Rmp with a level Vrst′ of the vertical signal line 309, and counts a count value over a period until the comparison result is inverted. Therefore, the P-phase level (reset level) is read.

Next, the vertical scanning circuit 211 supplies the high-level post-stage reset signal rstb [n] to the n-th row over the pulse period from timing T14 immediately after timing T13. Therefore, in a case where a parasitic capacitance exists in the post-stage node 340, the history of the previous signal held in the parasitic capacitance can be erased.

Next, the vertical scanning circuit 211 supplies the high-level switching signal φs[n] to the n-th row over a period from timing T15 immediately after the initialization of the post-stage node 340 to timing T17. The potential of the post-stage node 340 becomes the signal level Vsig. During exposure, the signal level is lower than the reset level, but during reading, the signal level is higher than the reset level because the post-stage node 340 is used as a reference. A difference between the reset level Vrst and the signal level Vsig corresponds to a net signal level from which reset noise and offset noise of the FD 314 have been removed.

In addition, the DAC 214 gradually increases the level of the ramp signal Rmp over a period from timing T16 after timing T15 to timing T17. The ADC 261 compares the ramp signal Rmp with the level Vrst′ of the vertical signal line 309, and counts a count value over a period until the comparison result is inverted. Therefore, the D-phase level (signal level) is read.

In addition, the vertical scanning circuit 211 controls the current source transistor 316 of the n-th row to be read over the period from timing T10 to timing T17 to supply the current id1 [n]. In addition, the timing control circuit 212 controls the load MOS transistors 251 of all the columns to supply the current id2 within the read period of all the rows.

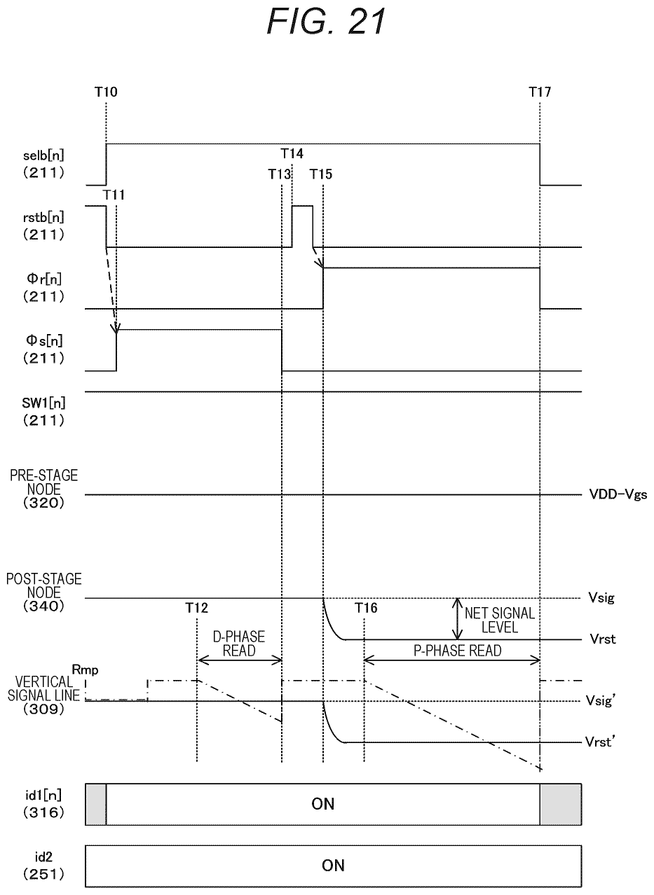

Note that the solid-state imaging element 200 reads the signal level after the reset level, but the read order is not limited to this order. Alternatively, as illustrated in FIG. 21, the solid-state imaging element 200 may read the reset level after the signal level. In this case, as illustrated in the drawing, the vertical scanning circuit 211 supplies the high-level switching signal φr after the high-level switching signal φs. At this time, the gradient of the slope of the ramp signal is reversed.

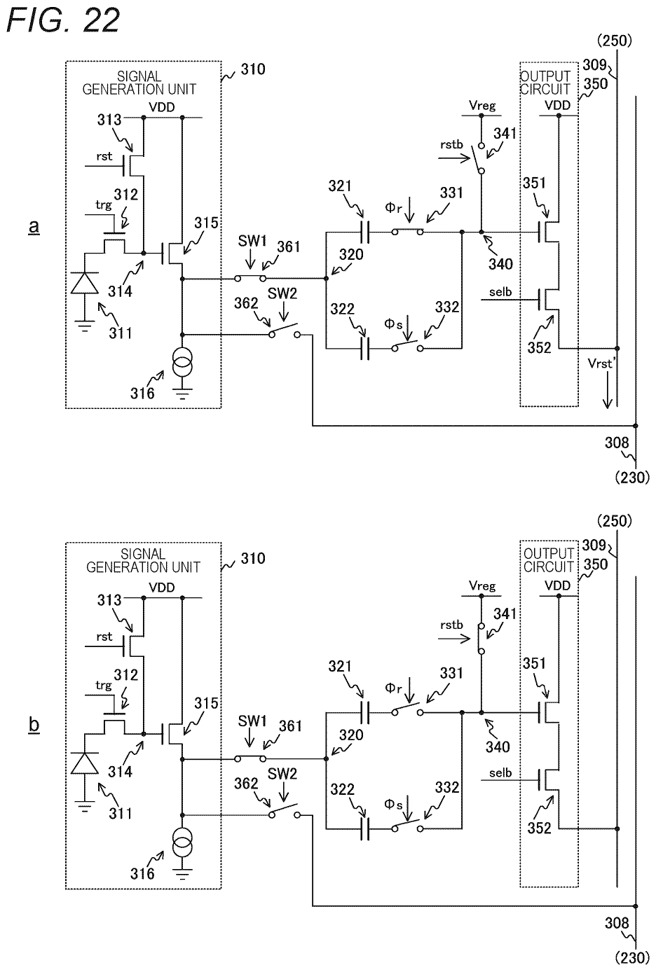

FIG. 22 is a diagram depicting examples of respective states of the pixel at the time of reading the reset level and at the time of initializing the post-stage node according to the sixth embodiment. In the drawing, a indicates a state of the pixel 300 at the time of reading the reset level, and b in the drawing indicates a state of the pixel 300 at the time of initializing the post-stage node 340. In addition, in the drawing, the switching transistors 331 332, 361, and 362, and the post-stage reset transistor 341 are represented by graphical symbols of switches for convenience of description.

As illustrated in a of the drawing, the vertical scanning circuit 211 closes the switching transistor 331, and opens the switching transistors 332, 361, and 362 and the post-stage reset transistor 341. As a result, the reset level is read via the output circuit 350.

Next, as illustrated in b of the drawing, after the reset level is read, the vertical scanning circuit 211 opens the switching transistors 331, 332, 361, and 362, and closes the post-stage reset transistor 341. As a result, the capacitor elements 321 and 322 are disconnected from the post-stage node 340, and the level of the post-stage node 340 is initialized.

The capacitance value of a parasitic capacitance Cp of the post-stage node 340 disconnected from the capacitor elements 321 and 322 in this manner is assumed to be very small as compared with the capacitor elements 321 and 322. For example, assuming that the parasitic capacitance Cp is several femtofarads (fF), the capacitor elements 321 and 322 are on the order of several tens of femtofarads.

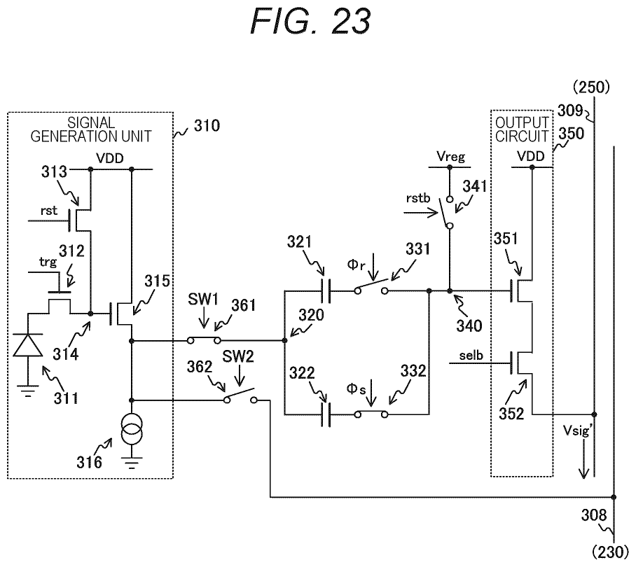

FIG. 23 is a diagram depicting an example of a state of the pixel 300 at the time of reading the signal level according to the sixth embodiment.

As illustrated in the drawing, the vertical scanning circuit 211 closes the switching transistor 332 and opens the switching transistors 331, 361, and 362 and the post-stage reset transistor 341 after the initialization of the post-stage node 340. As a result, the signal level is read via the output circuit 350.

Here, consider kTC noise at the time of exposure of the pixel 300. At the time of exposure, kTC noise occurs in each of sampling of the reset level and sampling of the signal level immediately before the end of exposure. Assuming that the capacitance value of each of the capacitor elements 321 and 322 is C, the level Vn of the kTC noise at the time of exposure is expressed by the following expression.

$$Vn = {( 2 * kT / C )}^{1 / 2} \qquad Expression 1$$

In addition, as illustrated in FIGS. 22 and 23, since the post-stage reset transistor 341 is driven at the time of reading, kTC noise occurs at that time. However, the capacitor elements 321 and 322 are disconnected at the time of driving the post-stage reset transistor 341, and the parasitic capacitance Cp at that time is small. Therefore, the kTC noise at the time of reading can be ignored as compared with the kTC noise at the time of exposure. Therefore, the kTC noise at the time of exposure and reading is expressed by Expression 1.

As described above, in the sixth embodiment, the post-stage reset transistor 341 initializes the post-stage node 340 when the switching transistors 331 and 332 disconnect the capacitor elements 321 and 322 from the post-stage node 340. Since the capacitor elements 321 and 322 are disconnected, the level of the reset noise generated by the driving becomes a level corresponding to a parasitic capacitance smaller than the capacitor elements 321 and 322. This noise reduction allows an improvement in image quality of image data.

In addition, opening the switching transistor 361 at the time of reading allows the signal generation unit 310 to be disconnected from the pre-stage node 320, thereby making it possible to block noise from the signal generation unit 310.

### First Modification Example

In the sixth embodiment described above, the pre-stage node 320 reads a signal in a floating state. A pixel 300 according to a first modification example of the sixth embodiment is provided with a pre-stage reset transistor 323 that clamps the potential of the pre-stage node 320 at the time of reading.

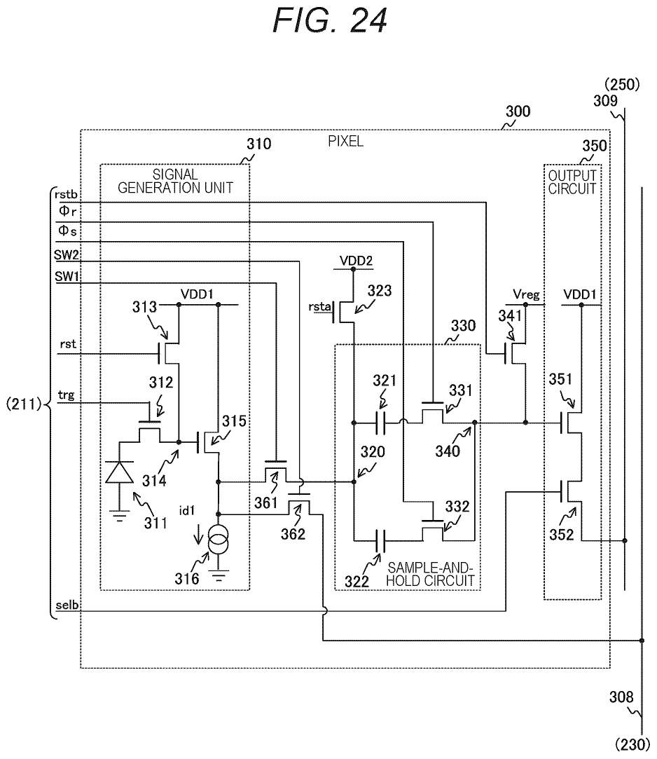

FIG. 24 is a circuit diagram depicting a configuration example of the pixel 300 according to the first modification example of the sixth embodiment. The pixel 300 of the first modification example of the sixth embodiment is different from the pixel 300 of the sixth embodiment in that the pre-stage reset transistor 323 is further provided. In addition, the power supply voltage of the signal generation unit 310 and the output circuit 350 of the first modification example of the sixth embodiment is denoted as VDD1.

The pre-stage reset transistor 323 is connected between a power supply voltage VDD2 and the pre-stage node 320. The pre-stage reset transistor 323 clamps the level of the pre-stage node 320 to the power supply voltage VDD2 at the time of reading in accordance with a pre-stage reset signal rsta from the vertical scanning circuit 211. It is desirable that the power supply voltage VDD2 be set to a value satisfying the following expression.

$$VDD 2 = VDD 1 - Vgs \qquad Expression 2$$

In the above expression, Vgs indicates the gate-source voltage of the pre-stage amplification transistor 315.

Setting to the value satisfying Expression 2 allow a reduction in variations in potential between the pre-stage node 320 and the post-stage node 340 in the dark. It is therefore possible to improve photo response non-uniformity (PRNU).

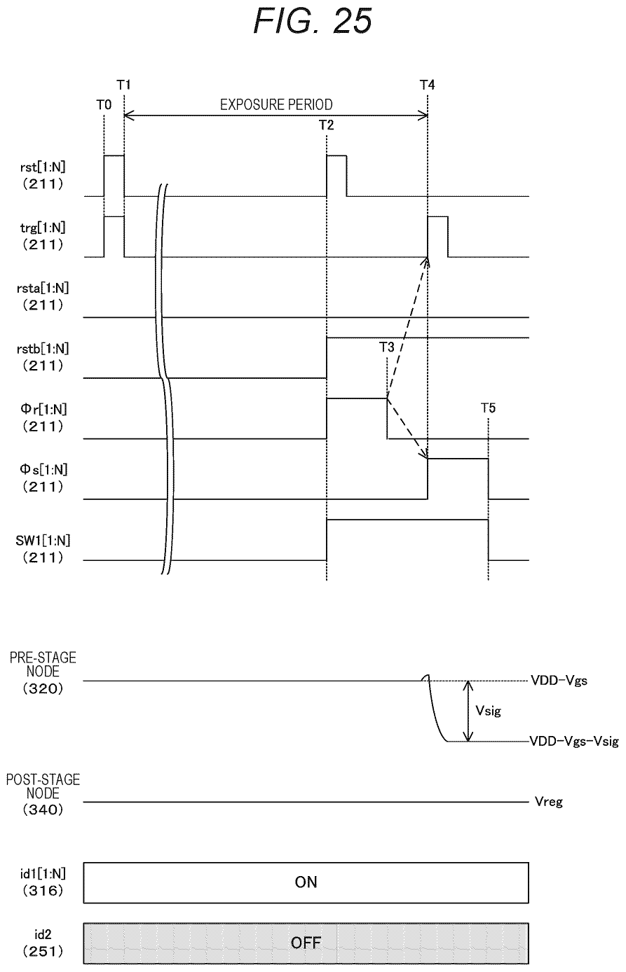

FIG. 25 is a timing chart depicting an example of a global shutter operation according to the first modification example of the sixth embodiment. The timing chart of the first modification example of the sixth embodiment is different from the timing chart of the sixth embodiment in that the vertical scanning circuit 211 further supplies the pre-stage reset signal rsta[1:N].

The vertical scanning circuit 211 supplies the high-level switching signal SW1[1:N] to all the pixels over a period from timing T2 immediately before the end of exposure to timing T5. The pre-stage reset signal rsta[1:N] is controlled to the low level.

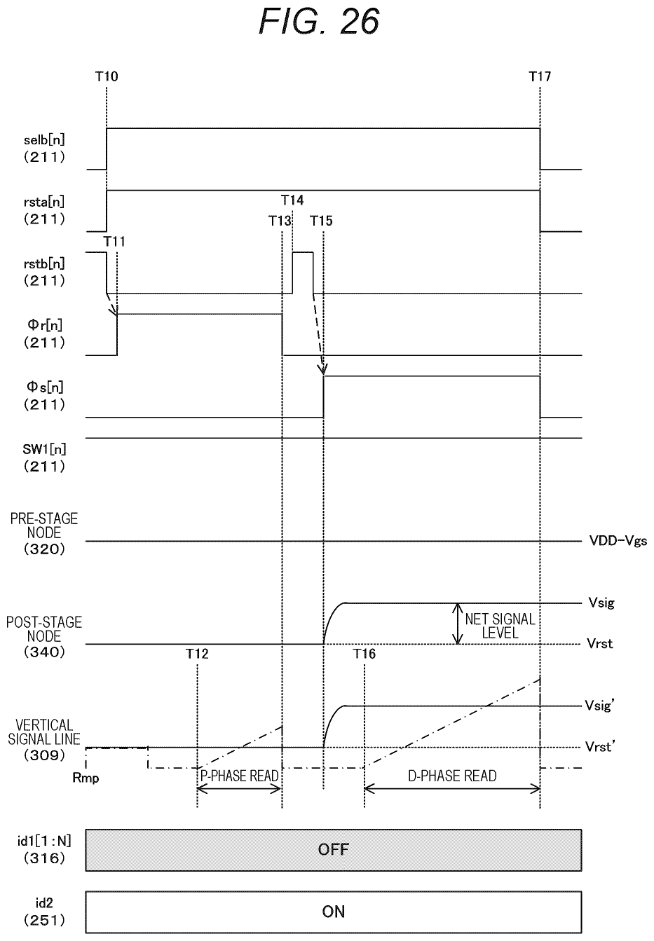

FIG. 26 is a timing chart depicting an example of a read operation according to the first modification example of the sixth embodiment. At the time of reading of each row, the switching signal SW1[n] is controlled to the low level. This control brings the switching transistor 361 into the open state to disconnect the pre-stage node 320 from the signal generation unit 310. It is therefore possible to block noise from the signal generation unit 310 at the time of reading.

In addition, the vertical scanning circuit 211 supplies the high-level pre-stage reset signal rsta[n] to the n-th row over the read period of the n-th row from timing T10 to timing T17.

In addition, at the time of reading, the vertical scanning circuit 211 controls the current source transistors 316 of all the pixels to stop the supply of the current id1 [1:N]. The current id2 is supplied in a manner similar to the sixth embodiment. As described above, the control of the current id1 [1:N] is simplified as compared with the sixth embodiment.

As described above, according to the first modification example of the sixth embodiment, since the pre-stage reset transistor 323 is brought into the closed state at the time of reading to clamp the potential of the pre-stage node 320, photo response non-uniformity (PRNU) can be improved.

### Second Modification Example

In the sixth embodiment described above, the circuits in the solid-state imaging element 200 are provided in a single semiconductor chip, but there is a possibility that this configuration prevents the element from fitting in the semiconductor chip in a case where the pixel 300 is miniaturized. A solid-state imaging element 200 of a second modification example of the sixth embodiment is different from the solid-state imaging element 200 of the sixth embodiment in that the circuits in the solid-state imaging element 200 are dispersedly arranged in two semiconductor chips.

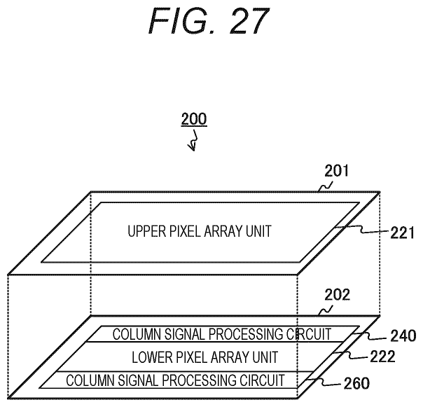

FIG. 27 is a diagram depicting an example of a laminated structure of the solid-state imaging element 200 according to the second modification example of the sixth embodiment. The solid-state imaging element 200 of the second modification example of the sixth embodiment includes a lower pixel chip 202 and an upper pixel chip 201 stacked on the lower pixel chip 202. These chips are electrically connected by, for example, Cu—Cu bonding. Note that, in addition to the Cu—Cu bonding, the connection can be made using a via or a bump.

An upper pixel array unit 221 is arranged in the upper pixel chip 201. A lower pixel array unit 222 and the column signal processing circuits 240 and 260 are arranged in the lower pixel chip 202. For each pixel in the pixel array unit 220, a part of the pixel is arranged in the upper pixel array unit 221, and the rest is arranged in the lower pixel array unit 222.

In addition, in the lower pixel chip 202, the vertical scanning circuit 211, the timing control circuit 212, the DACs 213 and 214, and the load MOS circuit blocks 230 and 250 are also arranged. These circuits are not depicted in the drawing.

In addition, the upper pixel chip 201 is manufactured, for example, by a pixel-dedicated process, and the lower pixel chip 202 is manufactured, for example, by a complementary MOS (CMOS) process.

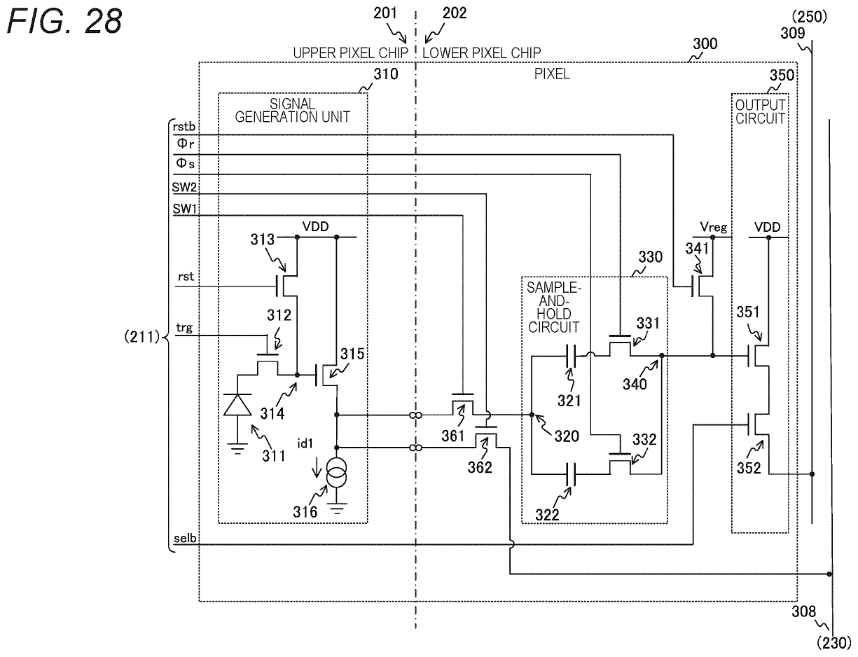

FIG. 28 is a circuit diagram depicting a configuration example of a pixel 300 according to the second modification example of the sixth embodiment. In the pixel 300, the signal generation unit 310 is arranged in the upper pixel chip 201, and the other circuits and elements (such as the capacitor elements 321 and 322) are arranged in the lower pixel chip 202. Note that the current source transistor 316 can be further arranged in the lower pixel chip 202. As illustrated in the drawing, dispersedly arranging the elements in the pixel 300 in the stacked upper pixel chip 201 and lower pixel chip 202 allows a reduction in per-chip pixel area, thereby facilitating pixel miniaturization.

As described above, according to the second modification example of the sixth embodiment, since the circuits and elements in the pixel 300 are dispersedly arranged in the two semiconductor chips, pixel miniaturization is facilitated.

### Third Modification Example

In the second modification example of the sixth embodiment described above, a part of the pixel 300 and the peripheral circuits (such as the column signal processing circuit 260) are provided in the lower pixel chip 202 on the lower side. However, in this configuration, the arrangement area of the circuits and elements on the lower pixel chip 202 side is larger than the arrangement area of the upper pixel chip 201 by the area of the peripheral circuits, and there is a possibility that an unnecessary space without circuits and elements is generated in the upper pixel chip 201. A solid-state imaging element 200 of the third modification example of the sixth embodiment is different from the solid-state imaging element 200 of the second modification example of the sixth embodiment in that the circuits in the solid-state imaging element 200 are dispersedly arranged in three semiconductor chips.

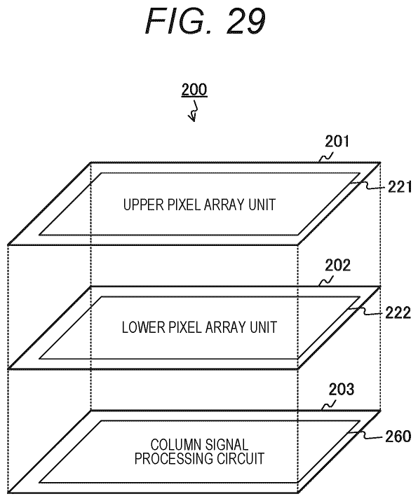

FIG. 29 is a diagram depicting an example of a laminated structure of the solid-state imaging element 200 according to the third modification example of the sixth embodiment. The solid-state imaging element 200 of the third modification example of the sixth embodiment includes the upper pixel chip 201, the lower pixel chip 202, and a circuit chip 203. These chips are stacked and are electrically connected by, for example, Cu—Cu bonding. Note that, in addition to the Cu—Cu bonding, the connection can be made using a via or a bump.

An upper pixel array unit 221 is arranged in the upper pixel chip 201. The lower pixel array unit 222 is arranged in the lower pixel chip 202. For each pixel in the pixel array unit 220, a part of the pixel is arranged in the upper pixel array unit 221, and the rest is arranged in the lower pixel array unit 222.

In addition, in the circuit chip 203, the column signal processing circuit 260, the vertical scanning circuit 211, the timing control circuit 212, the DAC 213, and the load MOS circuit block 250 are arranged.

Circuits other than the column signal processing circuit 260 are not depicted in the drawing.

Adopting the three-layer configuration as illustrated in the drawing allows a reduction in unnecessary space and allows further pixel miniaturization as compared with the two-layer configuration. In addition, the lower pixel chip 202 that is the second layer can be manufactured by a dedicated process for capacitors and switches.

As described above, in the third modification example of the sixth embodiment, since the circuits in the solid-state imaging element 200 are dispersedly arranged in the three semiconductor chips, the pixel can be further miniaturized as compared with a case where the circuits are dispersedly arranged in the two semiconductor chips.

### 7. Seventh Embodiment

In the sixth embodiment described above, the reset level is sampled and held in the exposure period, but this configuration prevents the exposure period from being shorter than the sample and hold period of the reset level. A solid-state imaging element 200 of the seventh embodiment is different from the solid-state imaging element 200 of the sixth embodiment in that a transistor that discharges charges from a photoelectric conversion element is added to make the exposure period shorter.

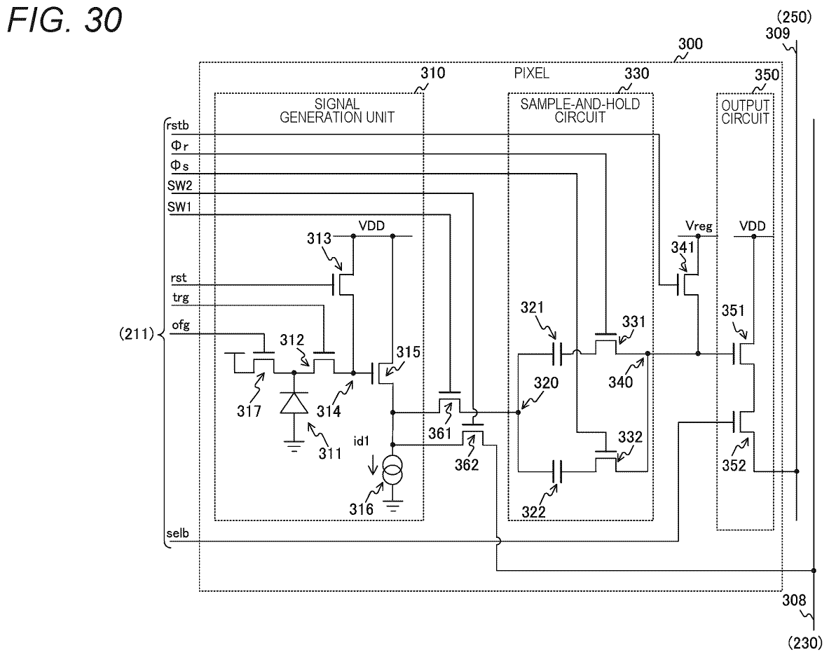

FIG. 30 is a circuit diagram depicting a configuration example of a pixel 300 according to the seventh embodiment. The pixel 300 of the seventh embodiment is different from the pixel 300 of the sixth embodiment in that a discharge transistor 317 is further provided in the signal generation unit 310.

The discharge transistor 317 is connected to a connection point between the photoelectric conversion unit 311 and the transfer transistor 312. The discharge transistor 317 functions as an overflow drain that discharges charges from the photoelectric conversion unit 311 in accordance with a discharge signal ofg from the vertical scanning circuit 211. As the discharge transistor 317, for example, an nMOS transistors is used.

The configuration without the discharge transistor 317 as in the sixth embodiment described above may suffer blooming when charges are transferred from the photoelectric conversion unit 311 to the FD 314 for all the pixels. Then, at the time of FD reset, the potential of the FD 314 and the potential of the pre-stage node 320 drop. In response to the potential drop, charging and discharging currents of the capacitor elements 321 and 322 continue to occur, and IR drop in the power supply or the ground changes from a steady state without blooming.

On the other hand, at the time of sampling and holding the signal levels of all the pixels, after the transfer of the signal charges, the photoelectric conversion unit 311 has no charge, so that blooming does not occur, and IR drop in the power supply or the ground goes into the steady state without blooming. Due to a difference between IR drop at the time of sampling and holding the reset level and IR drop at the time of sampling and holding the signal level, streaking noise occurs.

On the other hand, in the seventh embodiment in which the discharge transistor 317 is provided, the charges in the photoelectric conversion unit 311 are discharged toward the overflow drain. Therefore, IR drop at the time of sampling and holding the reset level and IR drop at the time of sampling and holding the signal level become almost identical to each other, so that it is possible to suppress streaking noise.

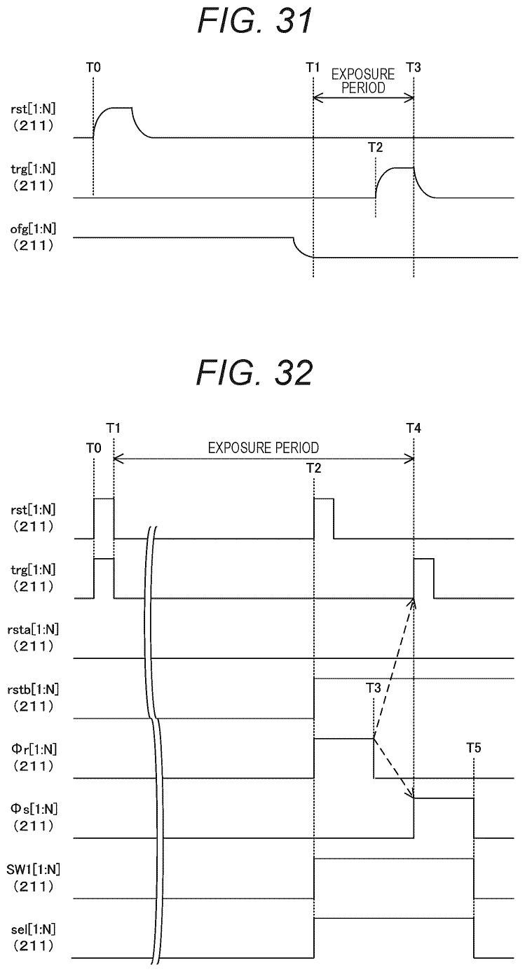

FIG. 31 is a timing chart depicting an example of a global shutter operation according to the seventh embodiment. At timing T0 before the start of exposure, the vertical scanning circuit 211 supplies the high-level FD reset signal rst[1:N] to all the pixels over the pulse period while setting the discharge signal ofg[1:N] to the high level for all the pixels. As a result, the PD reset and the FD reset are performed on all the pixels. In addition, the reset level is sampled and held.

Then, at timing T1 that is the start of exposure, the vertical scanning circuit 211 returns the discharge signal ofg[1:N] to the low level for all the pixels. Then, the vertical scanning circuit 211 supplies the high-level transfer signal trg[1:N] to all the pixels over a period from timing T2 immediately before the end of exposure to timing T3 that is the end of exposure. As a result, the signal level is sampled and held.

The configuration without the discharge transistor 317 as in the sixth embodiment needs to bring both the transfer transistor 312 and the FD reset transistor 313 into the on state at the start of exposure (that is, at the time of PD reset). Under this control, the FD 314 also needs to be reset at the time of PD reset. It is therefore necessary to perform the FD reset again within the exposure period to sample and hold the reset level, so that the exposure period cannot be made shorter than the sample and hold period of the reset level. When the reset levels of all the pixels are sampled and held, a certain waiting time is required until the voltage and the current settle, and for example, a sample and hold period of several microseconds (μs) to several tens of microseconds (μs) is required.

On the other hand, in the seventh embodiment in which the discharge transistor 317 is provided, the PD reset and the FD reset can be separately performed. Therefore, as illustrated in the drawing, it is possible to sample and hold the reset level by performing the FD reset before termination of the PD reset (the start of exposure). It is therefore possible to make the exposure period shorter than the sample and hold period of the reset level.

Note that, the first to third modification examples of the sixth embodiment may also be applied to the seventh embodiment.

As described above, according to the seventh embodiment, since the discharge transistor 317 that discharges charges from the photoelectric conversion unit 311 is provided, it is possible to sample and hold the reset level by performing the FD reset before the start of exposure. It is therefore possible to make the exposure period shorter than the sample and hold period of the reset level.

### 8. Eighth Embodiment

In the sixth embodiment described above, the reset level and the signal level are read in this order for each frame, but there is a possibility that this configuration causes deterioration of photo response non-uniformity (PRNU) due to variations of the capacitor elements 321 and 322 or parasitic capacitance. A solid-state imaging element 200 of the eighth embodiment is different from the solid-state imaging element 200 of the sixth embodiment in that PRNU is improved by switching between the level held in the capacitor element 321 and the level held in the capacitor element 322 for each frame.

The solid-state imaging element 200 of the eighth embodiment continuously captures a plurality of frames in synchronization with the vertical synchronization signal XVS. An odd-numbered frame is referred to as “odd frame”, and an even-numbered frame is referred to as “even frame”.

FIG. 32 is a timing chart depicting an example of a global shutter operation for the odd frame according to the eighth embodiment. The signal generation unit 310 sets the switching signal φr [1:N] and the switching signal φs [1:N] to the high level in this order within the exposure period of the odd frame to cause the capacitor element 321 to hold the reset level and then cause the capacitor element 322 to hold the signal level.

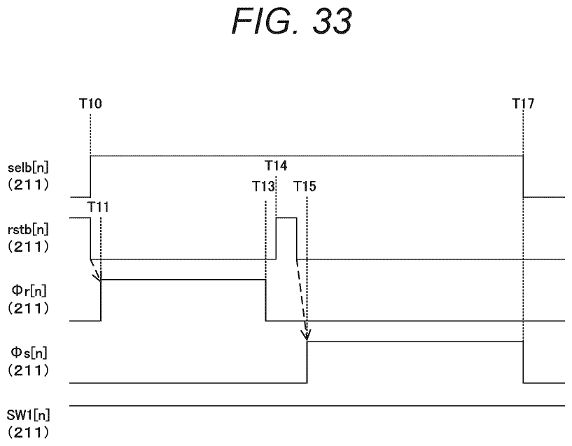

FIG. 33 is a timing chart depicting an example of a read operation for the odd frame according to the eighth embodiment. The output circuit 350 sets the switching signal φr [n] and the switching signal φs [n] to the high level in this order within the read period of the odd frame to read the reset level and the signal level in this order.

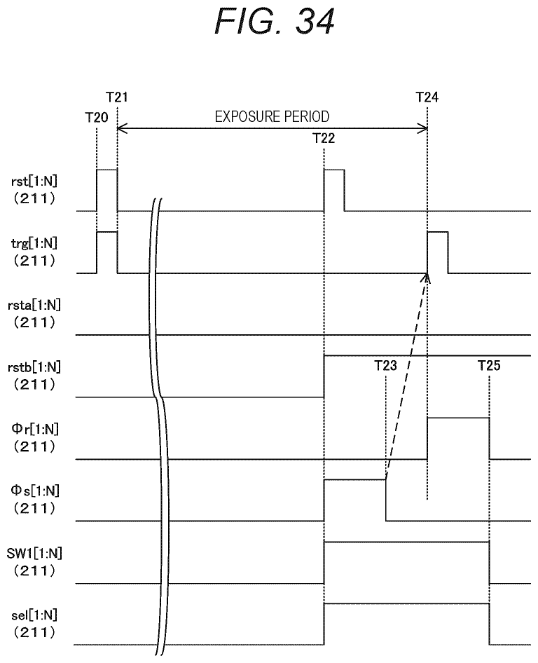

FIG. 34 is a timing chart depicting an example of a global shutter operation for the even frame according to the eighth embodiment. The signal generation unit 310 sets the switching signal φs [1:N] and the switching signal φr [1:N] to the high level in this order within the exposure period of the even frame to cause the capacitor element 322 to hold the reset level and then cause the capacitor element 321 to hold the signal level.

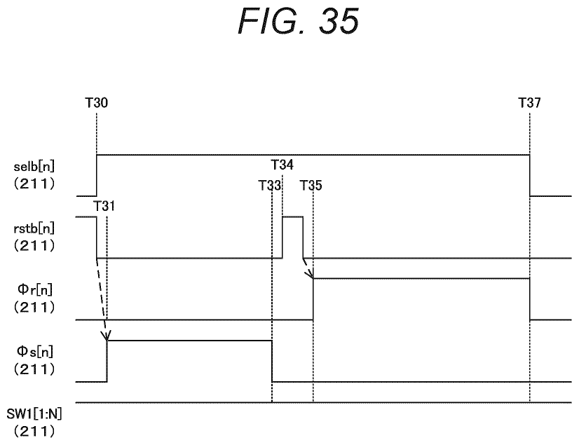

FIG. 35 is a timing chart depicting an example of a read operation for the even frame according to the eighth embodiment. The output circuit 350 sets the switching signal φs [n] and the switching signal φr[n] to the high level in this order within the read period of the even frame to read the reset level and the signal level in this order.

As illustrated in FIGS. 32 and 34, the levels held in the capacitor elements 321 and 322 are reversed between the even frame and the odd frame. This also reverses the polarity of PRNU between the even frame and the odd frame. The column signal processing circuit 260 in the subsequent stage obtains the average of the odd frame and the even frame. It is therefore possible to cancel out PRNU with opposite polarities.

This control is effective in capturing a moving image or adding up frames. In addition, it is not necessary to add an element to the pixel 300, and it can be realized only by changing a driving system.

Note that the first to third modification examples of the sixth embodiment or the seventh embodiment may also be applied to the eighth embodiment.

As described above, in the eighth embodiment, since the level held in the capacitor element 321 and the level held in the capacitor element 322 are reversed between the odd frame and the even frame, the polarity of PRNU can be reversed between the odd frame and the even frame. The column signal processing circuit 260 computes the average of the odd frame and the even frame, so that it is possible to suppress deterioration of PRNU.

### 9. Ninth Embodiment

In the sixth embodiment described above, the column signal processing circuit 260 obtains a difference between the reset level and the signal level for each column. There is, however, a possibility that this configuration suffers, when very high intensity light is incident on the pixel, a black spot phenomenon in which luminance decreases due to overflow of charges from the photoelectric conversion unit 311 and sinks into black. A solid-state imaging element 200 of the ninth embodiment is different from the solid-state imaging element 200 of the sixth embodiment in that whether or not the black spot phenomenon has occurred is determined for each pixel.

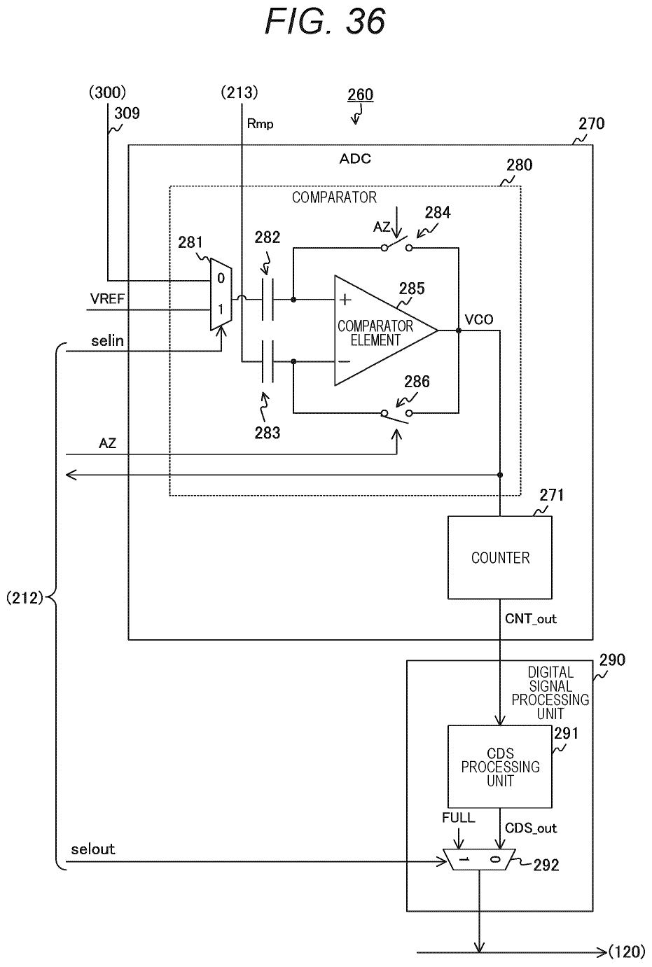

FIG. 36 is a circuit diagram depicting a configuration example of a column signal processing circuit 260 according to the ninth embodiment. In the column signal processing circuit 260 of the ninth embodiment, a plurality of ADCs 270 and a digital signal processing unit 290 are arranged. In addition, in the digital signal processing unit 290, a plurality of CDS processing units 291 and a plurality of selectors 292 are arranged. The ADC 270, the CDS processing unit 291, and the selector 292 are provided for each column.

In addition, the ADC 270 includes a comparator 280 and a counter 271. The comparator 280 compares the level of the vertical signal line 309 with the ramp signal Rmp from the DAC 214, and outputs a comparison result VCO. The comparison result VCO is supplied to the counter 271 and the timing control circuit 212. The comparator 280 includes a selector 281, capacitor elements 282 and 283, auto-zero switches 284 and 286, and a comparator element 285.

The selector 281 connects either the vertical signal line 309 of the corresponding column or a node of a predetermined reference voltage VREF to a non-inverting input terminal (+) of the comparator element 285 via the capacitor element 282 in accordance with an input-side selection signal selin. The input-side selection signal selin is supplied from the timing control circuit 212. The ramp signal Rmp is input to an inverting input terminal (−) via the capacitor element 283.

The comparator element 285 compares a level of the non-inverting input terminal (+) with a level of the inverting input terminal (−), and outputs the comparison result VCO to the counter 271.

The auto-zero switch 284 short-circuits the non-inverting input terminal (+) and an output terminal of the comparison result VCO in accordance with an auto-zero signal AZ from the timing control circuit 212. The auto-zero switch 286 short-circuits the inverting input terminal (−) and the output terminal of the comparison result VCO in accordance with the auto-zero signal AZ.

The counter 271 counts a count value over a period until the comparison result VCO is inverted, and outputs a digital signal CNT_out indicating the count value to the CDS processing unit 291.

The CDS processing unit 291 performs CDS processing on the digital signal CNT_out. The CDS processing unit 291 calculates a difference between the digital signal CNT_out corresponding to the reset level and the digital signal CNT_out corresponding to the signal level, and outputs the difference to the selector 292 as CDS_out.

The selector 292 outputs, in accordance with an output-side selection signal selout from the timing control circuit 212, either the digital signal CDS_out subjected to the CDS processing or a full-code digital signal FULL as pixel data of the corresponding column.

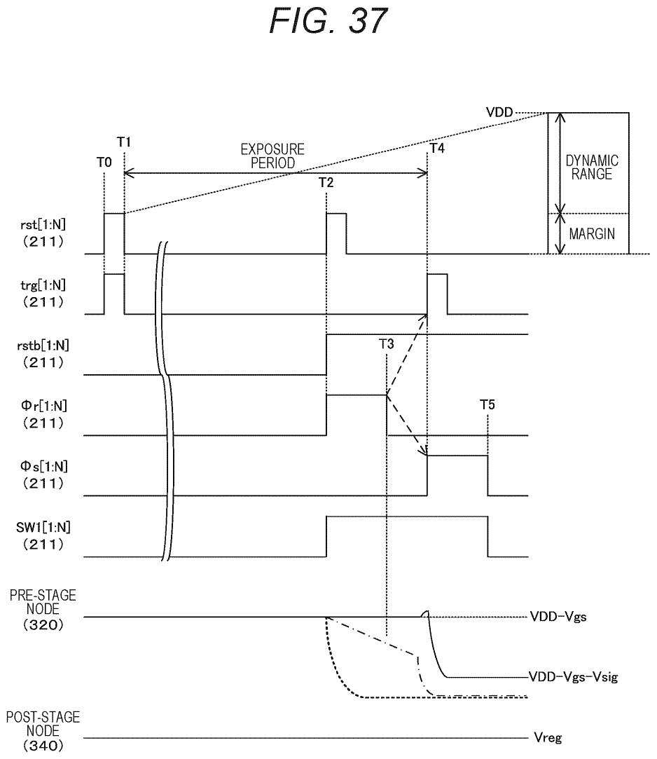

FIG. 37 is a timing chart depicting an example of a global shutter operation according to the ninth embodiment. A method for controlling transistors at the time of global shutter of the ninth embodiment is similar to the method of the sixth embodiment.

Here, it is assumed that very high intensity light is incident on the pixel 300. In this case, the photoelectric conversion unit 311 becomes full of charges, and the charges overflow from the photoelectric conversion unit 311 to the FD 314, thereby causing a decrease in potential of the FD 314 subjected to the FD reset. A long dashed short dashed line in the drawing indicates variations in potential of the FD 314 when weak sunlight that causes a relatively small amount of charges to overflow is incident. A dotted line in the drawing indicates variations in potential of the FD 314 when strong sunlight that causes a relatively large amount of charges to overflow is incident.

When weak sunlight is incident, the reset level is dropping at timing T3 that is the end of the FD reset, but the level does not fully drop at this time.

On the other hand, when strong sunlight is incident, the reset level fully drops at timing T3. In this case, the signal level becomes the same as the reset level, and the potential difference between the signal level and the reset level becomes “O”, so that the digital signal subjected to the CDS processing becomes the same as a digital signal in a dark state and sinks into black. As described above, a phenomenon in which the pixel becomes black even though very high intensity light such as sunlight is incident is called a black spot phenomenon or blooming.

In addition, when the level of the FD 314 of the pixel in which the black spot phenomenon has occurred is too low, the operating point of the signal generation unit 310 cannot be secured, and the current id1 of the current source transistor 316 varies accordingly. Since the current source transistor 316 of each pixel is connected to a common power supply or ground, when a certain pixel suffers variations in current, variations in IR drop in the pixel affect a sample level of another pixel. A pixel in which the black spot phenomenon occurs becomes an aggressor, and a pixel in which the sample level varies in a manner that depends on the pixel (aggressor) becomes a victim. As a result, streaking noise occurs.

Note that, in a case where the discharge transistor 317 is provided as in the seventh embodiment, in a pixel suffering a black spot (blooming), overflow charges are discharged toward the discharge transistor 317, so that the black spot phenomenon is less likely to occur. However, even if the discharge transistor 317 is provided, some charges may flow to the FD 314, and there is a possibility that the black spot phenomenon is difficult to get rid of completely. Further, there is also a disadvantage that a ratio of the effective area/the charge amount for each pixel decreases due to the addition of the discharge transistor 317. It is therefore desirable to suppress the black spot phenomenon without using the discharge transistor 317.

As a method for suppressing the black spot phenomenon without using the discharge transistor 317, there are two possible methods. The first is adjustment of a clip level of the FD 314. The second is a method in which whether or not the black spot phenomenon has occurred at the time of reading is determined, and when the black spot phenomenon has occurred, the output is replaced with the full code.

Under the first method, the high level of the FD reset signal rst (in other words, the gate of the FD reset transistor 313) in the drawing corresponds to the power supply voltage VDD, and the low level corresponds to the clip level of the FD 314. In the sixth embodiment, a difference between the high level and the low level (that is, amplitude) is set to a value corresponding to a dynamic range. On the other hand, in the ninth embodiment, the value is adjusted to a value plus an additional margin. Here, the value corresponding to the dynamic range corresponds to a difference between the power supply voltage VDD and the potential of the FD 314 when the digital signal becomes the full code.

Lowering the gate voltage (the low level of the FD reset signal rst) when the FD reset transistor 313 is off makes it possible to prevent the FD 314 from being excessively lowered due to blooming and the operating point of the pre-stage amplification transistor 315 from being lost.

Note that the dynamic range varies in a manner that depends on the analog gain of the ADC. When the analog gain is low, the dynamic range needs to be larger, and on the other hand, when the analog gain is high, the dynamic range can be less. It is therefore possible to change the gate voltage when the FD reset transistor 313 is off in accordance with the analog gain.

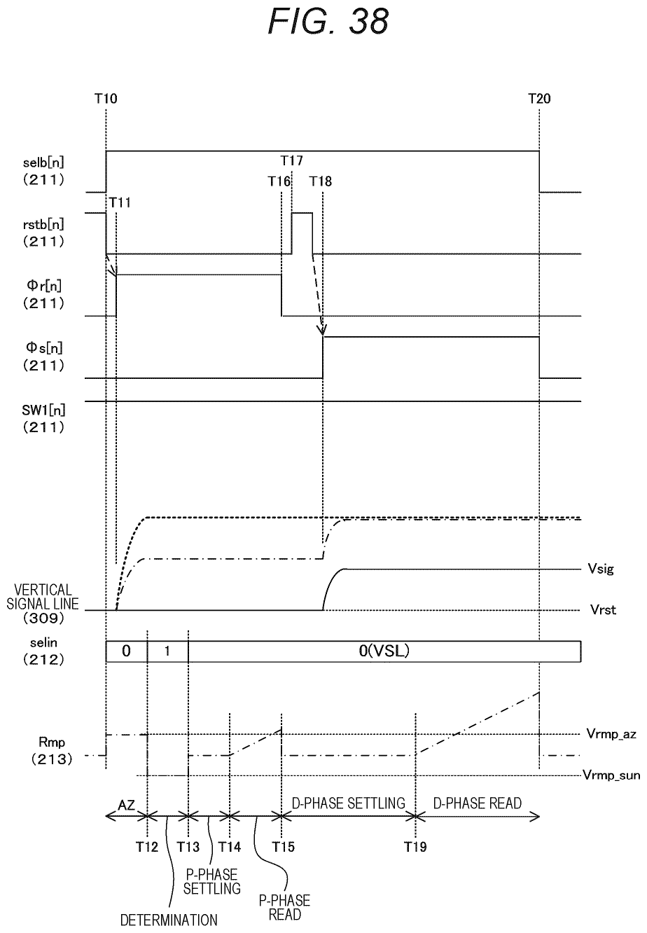

FIG. 38 is a timing chart depicting an example of a read operation according to the ninth embodiment. When the switching signal φr becomes the high level at timing T11 immediately after timing T10 that is the start of reading, the potential of the vertical signal line 309 varies in the pixel on which sunlight is incident. A long dashed short dashed line in the drawing indicates variations in potential of the vertical signal line 309 when weak sunlight is incident. A dotted line in the drawing indicates variations in potential of the vertical signal line 309 when strong sunlight is incident.

In an auto-zero period from timing T10 to timing T12, the timing control circuit 212 supplies, for example, the input-side selection signal selin of “0” to connect the comparator element 285 to the vertical signal line 309. Within this auto-zero period, the timing control circuit 212 performs auto-zeroing using the auto-zero signal AZ.

Under the second method, the timing control circuit 212 supplies, for example, the input-side selection signal selin of “1” within a determination period from timing T12 to timing T13. The input-side selection signal selin disconnects the comparator element 285 from the vertical signal line 309 and connects the comparator element 285 to the node of the reference voltage VREF. The reference voltage VREF is set to an expected value of the level of the vertical signal line 309 when blooming does not occur. For example, when the gate-source voltage of the post-stage amplification transistor 351 is denoted as Vgs2, Vrst corresponds to Vreg−Vgs2. In addition, the DAC 214 lowers the level of the ramp signal Rmp from Vrmp_az to Vrmp_sun within the determination period.

In addition, in a case where blooming does not occur within the determination period, the reset level Vrst of the vertical signal line 309 is almost the same as the reference voltage VREF, and is not much different from when the potential of the inverting input terminal (+) of the comparator element 285 is auto-zero. On the other hand, since the non-inverting input terminal (−) lowers from Vrmp_az to Vrmp_sun, the comparison result VCO becomes the high level.

Conversely, in a case where blooming occurs, the reset level Vrst becomes sufficiently higher than the reference voltage VREF, and the comparison result VCO becomes the low level when the following expression is satisfied.

$$Vrst - VREF > Vrmp\_az - Vrmp\_sun \qquad Expression 3$$

That is, the timing control circuit 212 can determine whether or not blooming has occurred on the basis of whether or not the comparison result VCO becomes the low level within the determination period.

Note that it is necessary to secure some large margin for sun determination (the right side of Expression 3) so as to prevent erroneous determination due to variations in threshold voltage of the post-stage amplification transistor 351, IR drop differences of the in-plane Vreg, or the like.

After timing T13 that is the end of the determination period, the timing control circuit 212 connects the comparator element 285 to the vertical signal line 309. In addition, after the end of a P-phase settling period from timing T13 to timing T14, the P-phase is read within a period from timing T14 to timing T15. After the end of a D-phase settling period from timing T15 to timing T19, the D-phase is read within a period from timing T19 to timing T20.

When determining that blooming has not occurred in the determination period, the timing control circuit 212 controls the selector 292 in accordance with the output-side selection signal selout to output the digital signal CDS_out subjected to the CDS processing as it is.

On the other hand, when determining that blooming has occurred in the determination period, the timing control circuit 212 controls the selector 292 in accordance with the output-side selection signal selout to output the full-code digital signal FULL instead of the digital signal CDS_out subjected to the CDS processing. It is therefore possible to suppress the black spot phenomenon.

Note that the first to third modification examples of the sixth embodiment or the seven and eighth embodiments may also be applied to the ninth embodiment.

As described above, according to the ninth embodiment, since the timing control circuit 212 determines whether or not the black spot phenomenon has occurred on the basis of the comparison result VCO, and outputs the full code when the black spot phenomenon has occurred, it is possible to suppress the black spot phenomenon.

Note that, in the ninth embodiment described above, the method for suppressing the black spot phenomenon during the GS operation has been described, but the method may be applied to a method for suppressing the black spot phenomenon during the RS operation in the first to fifth embodiments described above.

### 10. Tenth Embodiment

In the first embodiment described above, the capacitor elements 321 and 322 and the switching transistors 331 and 332 are provided as a sample-and-hold circuit, but in the tenth embodiment, capacitors C1 and C2 are provided as a sample-and-hold circuit.

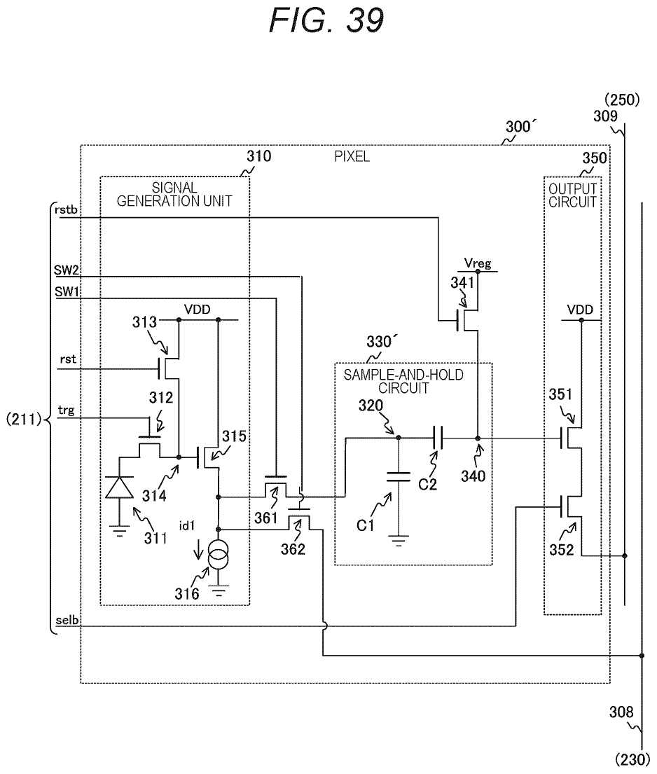

FIG. 39 is a circuit diagram depicting a configuration example of a pixel according to the tenth embodiment.

In the drawing, the pixel 300′ includes a sample-and-hold circuit 330′ instead of the sample-and-hold circuit 330 of the first embodiment described above. Other configurations of the pixel 300′ of the tenth embodiment are similar to those of the pixel 300 of the first embodiment described above.

The pixel 300′ includes the capacitors C1 and C2. The capacitor C1 is connected between the pre-stage node 320 and the ground potential. The capacitor C2 is connected between the pre-stage node 320 and the post-stage node 340.

Exposure control and read control of the pixel of the tenth embodiment are described in, for example, FIG. 5.5.2 of Non-Patent Document 1. In the tenth embodiment, assuming that the capacitance value of each of the capacitors C1 and C2 is C, a level Vn of kTC noise at the time of exposure and reading is expressed by the following expression.

$$Vn = {( 3 * kT / C )}^{1 / 2} \qquad Expression 4$$

In the above expression, k is a Boltzmann constant, and the unit is, for example, Joule per Kelvin (J/K). T is an absolute temperature, and the unit is, for example, Kelvin (K). In addition, the unit of Vn is, for example, volt (V), and the unit of C is, for example, farad (F).

As described above, according to the tenth embodiment described above, it is possible to eliminate, by providing the capacitors C1 and C2 as the sample-and-hold circuit, the need of the switching transistors 331 and 332 of the first embodiment described above.

### 11. Example of Application to Mobile Object

The technology according to the present disclosure (the present technology) can be applied to various products. For example, the technology of the present disclosure may be achieved in the form of a device to be mounted on a mobile object of any kind, such as an automobile, an electric vehicle, a hybrid electric vehicle, a motorcycle, a bicycle, a personal mobility, an airplane, a drone, a vessel, or a robot.

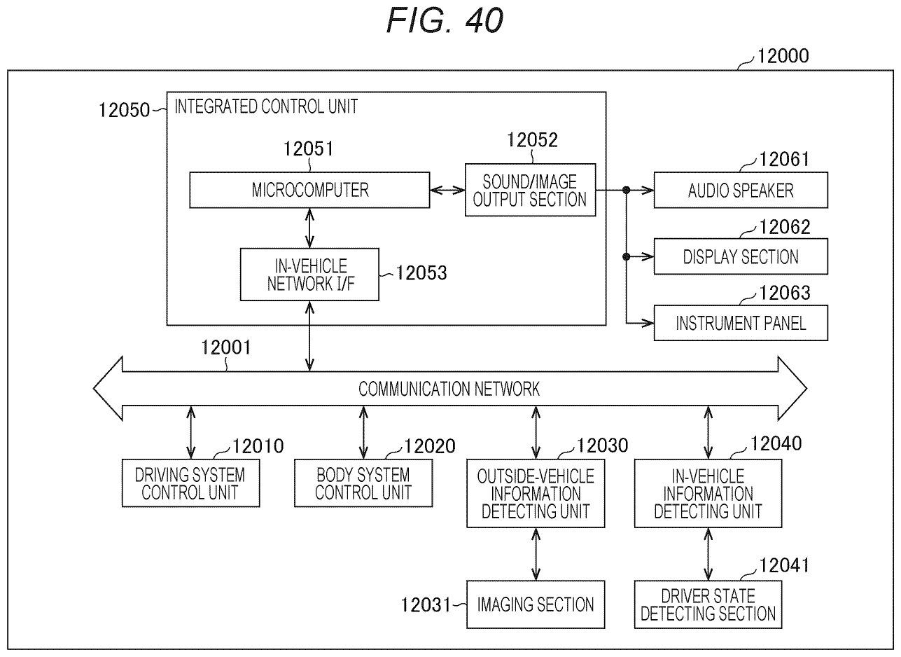

FIG. 40 is a block diagram depicting an example of schematic configuration of a vehicle control system as an example of a mobile object control system to which the technology according to an embodiment of the present disclosure can be applied.

The vehicle control system 12000 includes a plurality of electronic control units connected to each other via a communication network 12001. In the example depicted in FIG. 40, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and an in-vehicle network interface (I/F) 12053 are illustrated as functional components of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example in FIG. 40, an audio speaker 12061, a display section 12062, and an instrument panel 12063 are illustrated as the output device. The display section 12062 may, for example, include at least one of an on-board display and a head-up display.

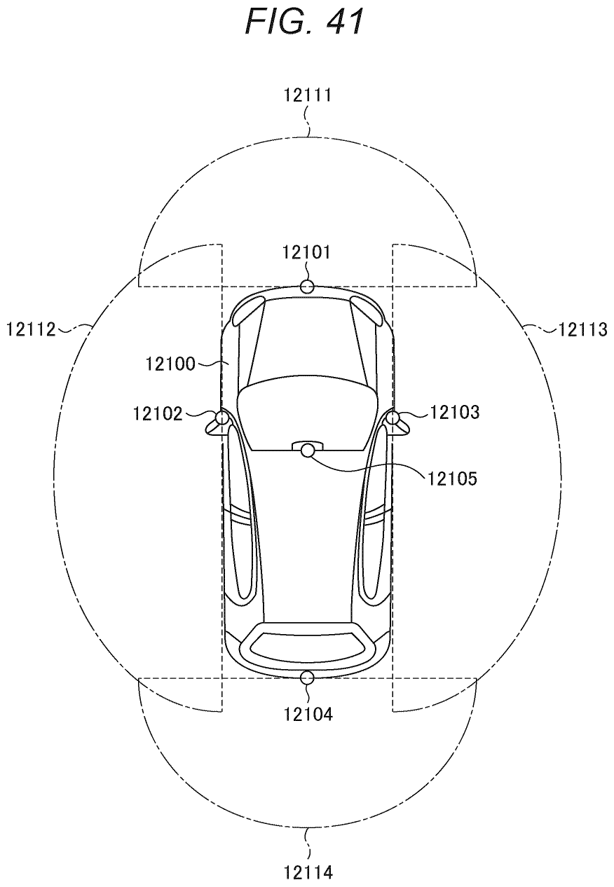

FIG. 41 is a diagram depicting an example of the installation position of the imaging section 12031.

In FIG. 41, the imaging section 12031 includes imaging sections 12101, 12102, 12103, 12104, and 12105.

The imaging sections 12101, 12102, 12103, 12104, 12105 are provided, for example, at positions such as a front nose, a sideview mirror, a rear bumper, a back door, and an upper portion of a windshield in the interior of a vehicle 12100. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Incidentally, FIG. 41 depicts an example of photographing ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

An example of the vehicle control system to which the technology according to the present disclosure can be applied has been described above. The technology according to the present disclosure may be applied to the imaging section 12031 in the configuration described above. Specifically, for example, the imaging device 100 in FIG. 1 can be applied to the imaging section 12031. By applying the technology according to the present disclosure to the imaging section 12031, kTC noise can be reduced, and a more easily viewable captured image can be obtained, so that driver's fatigue can be reduced.

Note that the embodiments described above show examples for embodying the present technology, and the matters in the embodiments and the matters specifying the invention in the claims have correspondence relationships. Similarly, the matters specifying the invention in the claims and matters with the same names in the embodiments of the present technology have correspondence relationships. However, the present technology is not limited to the embodiments, and can be embodied by applying various modifications to the embodiments without departing from the gist of the present technology. In addition, effects described in the present specification are merely examples and are not limited, and other effects may be provided.

Note that the present technology may also have the following configurations.

(1) An imaging device including:
a signal generation unit configured to generate a signal on the basis of charges read from a photoelectric conversion unit;
a sample-and-hold circuit configured to hold the signal generated by the signal generation unit;
a first vertical signal line configured to transmit the signal read from the sample-and-hold circuit;
a second vertical signal line configured to transmit the signal generated by the signal generation unit;
a first switch provided between the signal generation unit and the sample-and-hold circuit; and
a second switch provided between the signal generation unit and the second vertical signal line.

(2) The imaging device according to the above (1), further including:
a first analog to digital converter (ADC) configured to perform AD conversion on the signal output to the first vertical signal line for each column; and
a second ADC configured to perform AD conversion on the signal output to the second vertical signal line for each column.

(3) The imaging device according to the above (2), further including:
a first interface configured to transmit a signal output from the first ADC to outside; and
a second interface configured to transmit a signal output from the second ADC to outside.

(4) The imaging device according to the above (2), further including an interface configured to transmit a signal output from the first ADC and a signal output from the second ADC to outside in a time-division manner.

(5) The imaging device according to any one of the above (1) to (4), further including a vertical scanning circuit configured to control timing at which the signal read from the sample-and-hold circuit is output to the first vertical signal line and timing at which the signal generated by the signal generation unit is output to the second vertical signal line.

(6) The imaging device according to the above (5), in which
the vertical scanning circuit causes the signal generated by the signal generation unit to be output to the second vertical signal line while the signal read from the sample-and-hold circuit is being output to the first vertical signal line.

(7) The imaging device according to the above (5) or (6), in which the vertical scanning circuit causes a signal generated by exposure using a global shutter method to be held in the sample-and-hold circuit and
causes a signal generated by exposure using a rolling shutter method to be output to the second vertical signal line.

(8) The imaging device according to any one of the above (5) to (7), in which
the vertical scanning circuit causes the signal generated by the signal generation unit to be output to the second vertical signal line a plurality of times within a vertical synchronization period.

(9) The imaging device according to any one of the above (1) to (8), in which
the signal generated by the signal generation unit includes at least one of region of interest (ROI) image data, reduced image data, or phase difference data.

(10) The imaging device according to any one of the above (1) to (9), further including a control unit configured to control at least one of a global shutter operation or a rolling shutter operation on the basis of the signal transmitted through the second vertical signal line.

(11) The imaging device according to any one of the above (1) to (10), in which
the signal generation unit includes:
a readout transistor configured to read the charges from the photoelectric conversion unit;
a floating diffusion configured to hold the charges read by the readout transistor;
an amplification transistor configured to generate the signal on the basis of a potential of the floating diffusion; and
a reset transistor configured to reset the charges held in the floating diffusion, and
the sample-and-hold circuit includes:
a first capacitor element having one end connected to the first switch;
a second capacitor element having one end connected to the first switch;
a first switching transistor connected in series to the first capacitor element; and
a second switching transistor connected in series to the second capacitor element.

(12) The imaging device according to the above (11), further including:
an output circuit configured to output the signal held in the sample-and-hold circuit to the first vertical signal line; and
a post-stage reset transistor configured to initialize a level of a connection point between the sample-and-hold circuit and the output circuit when both the first and second capacitor elements are disconnected from the output circuit.

(13) An image processing device including:
a pixel array unit in which a pixel provided with a sample-and-hold circuit is arranged in a row direction and a column direction;
a first output unit configured to output a signal from the sample-and-hold circuit on the basis of a global shutter operation;
a second output unit configured to output, from the pixel, a signal that has skipped the sample-and-hold circuit on the basis of a rolling shutter operation;
a first processing unit configured to process the signal output from the first output unit;
a second processing unit configured to process the signal output from the second output unit; and
a combining unit configured to combine the signal processed by the first processing unit and the signal processed by the second processing unit.

(14) The image processing device according to the above (13), in which the pixel includes:
a photoelectric conversion unit;
a readout transistor configured to read charges from the photoelectric conversion unit;
a floating diffusion configured to hold the charges read by the readout transistor;
an amplification transistor configured to generate a signal corresponding to a potential of the floating diffusion; and
a reset transistor configured to reset the charges held in the floating diffusion.

(15) The image processing device according to the above (14), further including:
a first switch provided between the amplification transistor and the sample-and-hold circuit; and
a second switch provided between the amplification transistor and the second output unit, in which the sample-and-hold circuit includes:
a first capacitor element having one end connected to the first switch;
a second capacitor element having one end connected to the first switch;
a first switching transistor connected in series to the first capacitor element; and
a second switching transistor connected in series to the second capacitor element.

(16) The image processing device according to any one of the above (13) to (15), in which
the first output unit includes:
a first vertical signal line configured to transmit the signal read from the sample-and-hold circuit in the column direction; and
a first ADC configured to perform AD conversion on the signal output to the first vertical signal line for each column, and
the second output unit includes:
a second vertical signal line configured to transmit the signal that has skipped the sample-and-hold circuit in the column direction; and
a second ADC configured to perform AD conversion on the signal output to the second vertical signal line for each column.

(17) The image processing device according to any one of the above (13) to (16), in which
the signal that has skipped the sample-and-hold circuit is output from the pixel to the second output unit a plurality of times within a vertical synchronization period.

(18) The image processing device according to any one of the above (13) to (17), in which
the signal output from the pixel to the second output unit includes at least one of ROI image data, reduced image data, or phase difference data.

(19) The image processing device according to any one of the above (13) to (18), further including a control unit configured to control the pixel array unit on the basis of the signal processed by the second processing unit.

(20) An imaging device control method including:
generating a signal on the basis of charges read from a photoelectric conversion unit provided in a pixel;
holding, in the pixel, the signal generated in the pixel;
outputting the signal held in the pixel; and
outputting the signal generated in the pixel within an output period of the signal held in the pixel.

### REFERENCE SIGNS LIST

100 Imaging device
110 Imaging lens
120 Recording unit
130 Imaging control unit
140 Communication unit
200 Solid-state imaging element
201 Upper pixel chip
202 Lower pixel chip
203 Circuit chip
211 Vertical scanning circuit
212 Timing control circuit
213, 214 DAC
220 Pixel array unit
221 Upper pixel array unit
222 Lower pixel array unit
230, 250 Load MOS circuit block
251 Load MOS transistor
240, 260 Column signal processing circuit
261, 270 ADC
262, 290 Digital signal processing unit
271 Counter
280 Comparator
281, 292 Selector
282, 283, 321, 322 Capacitor element
284, 286 Auto-zero switch
285 Comparator element
291 CDS processing unit
300 Pixel
310 Signal generation unit
311 Photoelectric conversion unit
312 Transfer transistor
313 FD reset transistor
314 FD
315 Pre-stage amplification transistor
316 Current source transistor
317 Discharge transistor
321, 322 Capacitor element
323 Pre-stage reset transistor
330 Sample-and-hold circuit
331, 332 Switching transistor
361 Global transistor
362 Rolling transistor
341 Post-stage reset transistor
350 Output circuit
351 Post-stage amplification transistor
352 Post-stage selection transistor
12031 Imaging section

1. An imaging device comprising:
a signal generation unit configured to generate a signal on a basis of charges read from a photoelectric conversion unit;
a sample-and-hold circuit configured to hold the signal generated by the signal generation unit;
a first vertical signal line configured to transmit the signal read from the sample-and-hold circuit;
a second vertical signal line configured to transmit the signal generated by the signal generation unit;
a first switch provided between the signal generation unit and the sample-and-hold circuit; and
a second switch provided between the signal generation unit and the second vertical signal line.

2. The imaging device according to claim 1, further comprising:
a first analog to digital converter (ADC) configured to perform AD conversion on the signal output to the first vertical signal line for each column; and
a second ADC configured to perform AD conversion on the signal output to the second vertical signal line for each column.

3. The imaging device according to claim 2, further comprising:
a first interface configured to transmit a signal output from the first ADC to outside; and
a second interface configured to transmit a signal output from the second ADC to outside.

4. The imaging device according to claim 2, further comprising an interface configured to transmit a signal output from the first ADC and a signal output from the second ADC to outside in a time-division manner.

5. The imaging device according to claim 1, further comprising a vertical scanning circuit configured to control timing at which the signal read from the sample-and-hold circuit is output to the first vertical signal line and timing at which the signal generated by the signal generation unit is output to the second vertical signal line.

6. The imaging device according to claim 1, wherein
the vertical scanning circuit causes the signal generated by the signal generation unit to be output to the second vertical signal line while the signal read from the sample-and-hold circuit is being output to the first vertical signal line.

7. The imaging device according to claim 1, wherein the vertical scanning circuit causes a signal generated by exposure using a global shutter method to be held in the sample-and-hold circuit and
causes a signal generated by exposure using a rolling shutter method to be output to the second vertical signal line.

8. The imaging device according to claim 1, wherein
the vertical scanning circuit causes the signal generated by the signal generation unit to be output to the second vertical signal line a plurality of times within a vertical synchronization period.

9. The imaging device according to claim 1, wherein
the signal generated by the signal generation unit includes at least one of region of interest (ROI) image data, reduced image data, or phase difference data.

10. The imaging device according to claim 1, further comprising a control unit configured to control at least one of a global shutter operation or a rolling shutter operation on a basis of the signal transmitted through the second vertical signal line.

11. The imaging device according to claim 1, wherein
the signal generation unit includes:
a readout transistor configured to read the charges from the photoelectric conversion unit;
a floating diffusion configured to hold the charges read by the readout transistor;
an amplification transistor configured to generate the signal on a basis of a potential of the floating diffusion; and
a reset transistor configured to reset the charges held in the floating diffusion, and
the sample-and-hold circuit includes:
a first capacitor element having one end connected to the first switch;
a second capacitor element having one end connected to the first switch;
a first switching transistor connected in series to the first capacitor element; and
a second switching transistor connected in series to the second capacitor element.

12. The imaging device according to claim 11, further comprising:
an output circuit configured to output the signal held in the sample-and-hold circuit to the first vertical signal line; and
a post-stage reset transistor configured to initialize a level of a connection point between the sample-and-hold circuit and the output circuit when both the first and second capacitor elements are disconnected from the output circuit.

13. An image processing device comprising:
a pixel array unit in which a pixel provided with a sample-and-hold circuit is arranged in a row direction and a column direction;
a first output unit configured to output a signal from the sample-and-hold circuit on a basis of a global shutter operation;
a second output unit configured to output, from the pixel, a signal that has skipped the sample-and-hold circuit on a basis of a rolling shutter operation;
a first processing unit configured to process the signal output from the first output unit;
a second processing unit configured to process the signal output from the second output unit; and
a combining unit configured to combine the signal processed by the first processing unit and the signal processed by the second processing unit.

14. The image processing device according to claim 13, wherein the pixel includes:
a photoelectric conversion unit;
a readout transistor configured to read charges from the photoelectric conversion unit;
a floating diffusion configured to hold the charges read by the readout transistor;
an amplification transistor configured to generate a signal corresponding to a potential of the floating diffusion; and
a reset transistor configured to reset the charges held in the floating diffusion.

15. The image processing device according to claim 14, further comprising:
a first switch provided between the amplification transistor and the sample-and-hold circuit; and
a second switch provided between the amplification transistor and the second output unit, wherein
the sample-and-hold circuit includes:
a first capacitor element having one end connected to the first switch;
a second capacitor element having one end connected to the first switch;
a first switching transistor connected in series to the first capacitor element; and
a second switching transistor connected in series to the second capacitor element.

16. The image processing device according to claim 13, wherein
the first output unit includes:
a first vertical signal line configured to transmit the signal read from the sample-and-hold circuit in the column direction; and
a first ADC configured to perform AD conversion on the signal output to the first vertical signal line for each column, and
the second output unit includes:
a second vertical signal line configured to transmit the signal that has skipped the sample-and-hold circuit in the column direction; and
a second ADC configured to perform AD conversion on the signal output to the second vertical signal line for each column.

17. The image processing device according to claim 13, wherein
the signal that has skipped the sample-and-hold circuit is output from the pixel to the second output unit a plurality of times within a vertical synchronization period.

18. The image processing device according to claim 13, wherein
the signal output from the pixel to the second output unit includes at least one of ROI image data, reduced image data, or phase difference data.

19. The image processing device according to claim 13, further comprising a control unit configured to control the pixel array unit on a basis of the signal processed by the second processing unit.

20. An imaging device control method comprising:
generating a signal on a basis of charges read from a photoelectric conversion unit provided in a pixel;
holding, in the pixel, the signal generated in the pixel;
outputting the signal held in the pixel; and
outputting the signal generated in the pixel within an output period of the signal held in the pixel.
